(19) United States
(12) Patent Application Publication
(10) Pub. No.: US 2008/0009419 A1
(43) Pub. Date: Jan. 10, 2008

(54) GENETIC MODELS FOR STRATIFICATION OF CANCER RISK

(75) Inventors: David Ralph, Edmond, OK (US); Christopher Eric Aston, Shawnee, OK (US); Eldon Jupe, Norman, OK (US)

Correspondence Address: FULBRIGHT & JAWORSKI L.L.P., 600 CONGRESS AVE., SUITE 2400, AUSTIN, TX, 78701, US

(73) Assignees: INTERGENETICS, INC.; OKLAHOMA MEDICAL RESEARCH FOUNDATION

(21) Appl. No.: 11/767,009

(22) Filed: Jun. 22, 2007

Related U.S. Application Data
(60) Provisional application No. 60/805,692, filed on Jun. 23, 2006.

(51) Int. Cl. C40B 30/00; C40B 40/08

(52) U.S. Cl. 506/7; 506/17

(57) ABSTRACT

The present invention provides new methods for the assessment of cancer risk in the general population. These methods utilize particular alleles of selected genes, and particular combinations of genotypes, to identify individuals with increased or decreased risk of breast cancer. In addition, personal history measures such as age and race are used to further refine the analysis. Using such methods, it is possible to reallocate healthcare costs in cancer screening to patient subpopulations at increased cancer risk. It also permits identification of candidates for cancer prophylactic treatment.

The present application claims benefit of priority to U.S. Provisional Application Ser. No. 60/805,692, filed Jun. 23, 2006, the entire contents of which are hereby incorporated by reference.

The government owns rights in the present invention pursuant to grant number DAMD17-01-1-0358 from the United States Army Breast Cancer Research Program, and grant numbers AR992-007, AR01.1-050 and AR05.1025 from the Oklahoma Center for the Advancement of Science and Technology (OCAST).

### BACKGROUND OF THE INVENTION

1. Field of the Invention

The present invention relates generally to the fields of oncology and genetics. More particularly, it concerns use of univariate and multivariate analysis of genetic alleles constituting genotypes to determine genotypes and combinations of genotypes associated with low, intermediate and high risk of particular cancers. These risk alleles are used to screen patient samples, evaluation of incremental and lifetime risk of developing cancer, and efficiently direct patients towards prediagnostic cancer risk management and prophylaxis.

2. Description of Related Art

For patients with cancer, early diagnosis and treatment are the keys to better outcomes. In 2001, there are expected to be 1.25 million persons diagnosed with cancer in the United States. Tragically, in 2001 over 550,000 people are expected to die of cancer. To a very large extent, the difference between life and death for a cancer patient is determined by the stage of the cancer when the disease is first detected and treated. For those patients whose tumors are detected when they are relatively small and confined, the outcomes are usually very good. Conversely, if a patient's cancer has spread from its organ of origin to distant sites throughout the body, the patient's prognosis is very poor regardless of treatment. The problem is that tumors that are small and confined usually do not cause symptoms. Therefore, to detect these early stage cancers, it is necessary to continually screen or examine people without symptoms of illness. In such apparently healthy people, cancers are actually quite rare. Therefore it is necessary to screen a large number of people to detect a small number of cancers. As a result, annual or regularly administered cancer-screening tests are relatively expensive to administer in terms of the number of cancers detected per unit of healthcare expenditure.

A related problem in cancer screening is derived from the reality that no screening test is completely accurate. All tests deliver, at some rate, results that are either falsely positive (indicate that there is cancer when there is no cancer present) or falsely negative (indicate that no cancer is present when there really is a tumor present). Falsely positive cancer screening test results create needless healthcare costs because such results demand that patients receive follow-up examinations, frequently including biopsies, to confirm that a cancer is actually present. For each falsely positive result, the costs of such follow-up examinations are typically many times the costs of the original cancer-screening test. In addition, there are intangible or indirect costs associated with falsely positive screening test results derived from patient discomfort, anxiety and lost productivity. Falsely negative results also have associated costs. Obviously, a falsely negative result puts a patient at higher risk of dying of cancer by delaying treatment. To counter this effect, it might be reasonable to increase the rate at which patients are repeatedly screened for cancer. This, however, would add direct costs of screening and indirect costs from additional falsely positive results. In reality, the decision on whether or not to offer a cancer screening test hinges on a cost-benefit analysis in which the benefits of early detection and treatment are weighed against the costs of administering the screening tests to a largely disease free population and the associated costs of falsely positive results.

Another related problem concerns the use of chemopreventative drugs for cancer. Basically, chemopreventatives are drugs that are administered to prevent a patient from developing cancer. While some chemopreventative drugs may be effective, such drugs are not appropriate for all persons because the drugs have associated costs and possible adverse side effects (Reddy and Chow, 2000). Some of these adverse side effects may be life threatening. Therefore, decisions on whether to administer chemopreventative drugs are also based on a cost-benefit analysis. The central question is whether the benefits of reduced cancer risk outweigh the costs and associated risks of the chemopreventative treatment.

Currently, an individual's age is the most important factor in determining if a particular cancer-screening test should be offered to a patient. Truly, cancer is a rare disease in the young and a fairly common ailment in the elderly. The problem arises in screening and preventing cancers in the middle years of life when cancer can have its greatest negative impact on life expectancy and productivity. In the middle years of life, cancer is still fairly uncommon. Therefore, the costs of cancer screening and prevention can still be very high relative to the number of cancers that are detected or prevented. Decisions on when to begin screening also may be influenced by personal history or family history measures. Unfortunately, appropriate informatic tools to support such decision-making are not yet available for most cancers.

A common strategy to increase the effectiveness and economic efficiency of cancer screening and chemoprevention in the middle years of life is to stratify individuals' cancer risk and focus the delivery of screening and prevention resources on the high-risk segments of the population. Two such tools to stratify risk for breast cancer are termed the Gail Model and the Claus Model (Costantino et al., 1999; McTiernan et al., 2001). The Gail model is used as the “Breast Cancer Risk-Assessment Tool” software provided by the National Cancer Institute of the National Institutes of Health on their web site. Neither of these breast cancer models utilize genetic markers as part of their inputs. Furthermore, while both models are steps in the right direction, neither the Gail nor Clause models have the desired predictive power or discriminatory accuracy to truly optimize the delivery of breast cancer screening or chemopreventative therapies.

These issues and problems could be reduced in scope or even eliminated if it were possible to stratify or differentiate a given individual's risk from cancer more accurately than is now possible. If a precise measure of actual risk could be accurately determined, it would be possible to concentrate cancer screening and chemopreventative efforts in that segment of the population that is at highest risk. With accurate stratification of risk and concentration of effort in the high-risk population, fewer screening tests would be required to detect a greater number of cancers at an earlier and more treatable stage. Fewer screening tests would mean lower test administrative costs and fewer falsely positive results. A greater number of cancers detected would mean a greater net benefit to patients and other concerned parties such as health care providers. Similarly, chemopreventative drugs would have a greater positive impact by focusing the administration of these drugs to a population that receives the greatest net benefit.

### SUMMARY OF THE INVENTION

Thus, in accordance with the present invention, there is provided a method for assessing a female subject's risk for developing breast cancer comprising determining, in a sample from the subject, the allelic profile of more than one SNP selected from the group consisting of ACCa (IVS17) T→C, ACCa (5′UTR) T→C, ADPRT (rs1136410) C→T, CYP1A1 (rs4646903) T→C, CYP1B1 (rs1800440) A→G, GADD45 (rs681673) T→C, HLAh (rs1799945) C→G, HLAh (rs1800562) G→A, ICAM5 (rs1056538) G→A, KLK10 (Ala50Ser) G→T, KLK2 (rs198977) C→T, MPO463 (rs2333227) G→A, MSH6 (rs3136229) G→A, PGR (rs1042838) G→T, RAD51L3 (rs4796033) G→A, STK15 (rs2273535) T→A and TFR (rs3817672) A→G. The method may further comprise determining the allelic profile of (a) p27 (rs2066827) T→G and XRCC1 (rs25487) A→G; and/or (b) CYP11B2 (rs1799998) C→T and CYP17 (rs743572) T→C; and/or the method may further comprise determining the allelic profile of at least one additional SNP selected from the group consisting of CYP11B2 (rs1799998) C→T, CYP1B1 (rs10012) C→G, CYP17 5′UTR (rs743572) T→C, ERα (rs2077647) T→C, MMP2 (rs243865) C→T, MnSOD (rs1799725) T→C, p21 (rs1801270) C→A, p27 (rs2066827) T→G, p53 (rs1042522) G→C, UGT1A7 (rs17868324) CG→AA, VDR ApaI (rs7975232) G→T, VDR FokI (rs2228570) C→T, XPG (rs17655) G→C, and XRCC 1 (rs25487) A→G.

The method may also further comprise assessing one or more aspects of the subject's personal history, such as age, ethnicity, reproductive history, menstruation history, use of oral contraceptives, body mass index, alcohol consumption history, smoking history, exercise history, diet, family history of breast cancer or other cancer including the age of the relative at the time of their cancer diagnosis, and a personal history of breast cancer, breast biopsy or DCIS, LCIS, or atypical hyperplasia. Age may comprise stratification into a young age group of age 30-44 years, middle age group of age 45-54 years, and an old age group of 55 years and older.

The step of determining the allelic profile may be achieved by amplification of nucleic acid from the sample, such as by PCR, including chip-based assays using primers and primer pairs specific for alleles of the genes. The method may also further comprising cleaving the amplified nucleic acid. Samples may be derived from oral tissue collected by lavage or blood. The method may also further comprise making a decision on the timing and/or frequency of cancer diagnostic testing for the subject; and/or making a decision on the timing and/or frequency of prophylactic cancer treatment for the subject.

In another embodiment, there is provided a nucleic acid microarray comprising nucleic acid sequences corresponding to genes at least one of the alleles for each of ACCa (IVS17) T→C, ACCa (5′UTR) T→C, ADPRT (rs1136410) C→T, CYP1A1 (rs4646903) T→C, CYP1B1 (rs1800440) A→G, GADD45 (rs681673) T→C, HLAh (rs1799945) C→G, HLAh (rs1800562) G→A, ICAM5 (rs1056538) G→A, KLK10 (Ala50Ser) G→T, KLK2 (rs198977) C→T, MPO463 (rs2333227) G→A, MSH6 (rs3136229) G→A, PGR (rs1042838) G→T, RAD51L3 (rs4796033) G→A, STK15 (rs2273535) T→A and TFR (rs3817672) A→G. The nucleic acid sequences may comprise sequences for both alleles for each of the genes.

In still yet another embodiment, there is provided a method for determining the need for routine diagnostic testing of a female subject for breast cancer comprising determining, in a sample from the subject, the allelic profile of more than one SNP selected from the group consisting of ACCa (IVS17) T→C, ACCa (5′UTR) T→C, ADPRT (rs1136410) C→T, CYP1A1 (rs4646903) T→C, CYP1B1 (rs1800440) A→G, GADD45 (rs681673) T→C, HLAh (rs1799945) C→G, HLAh (rs1800562) G→A, ICAM5 (rs1056538) G→A, KLK10 (Ala50Ser) G→T, KLK2 (rs198977) C→T, MPO463 (rs2333227) G→A, MSH6 (rs3136229) G→A, PGR (rs1042838) G→T, RAD51L3 (rs4796033) G→A, STK15 (rs2273535) T→A and TFR (rs3817672) A→G.

In yet a further embodiment, there is provided a method for determining the need of a female subject for prophylactic anti-breast cancer therapy comprising determining, in a sample from the subject, the allelic profile of more than one SNP selected from the group consisting of ACCa (IVS17) T→C, ACCa (5′UTR) T→C, ADPRT (rs1136410) C→T, CYP1A1 (rs4646903) T→C, CYP1B1 (rs1800440) A→G, GADD45 (rs681673) T→C, HLAh (rs1799945) C→G, HLAh (rs1800562) G→A, ICAM5 (rs1056538) G→A, KLK10 (Ala50Ser) G→T, KLK2 (rs198977) C→T, MPO463 (rs2333227) G→A, MSH6 (rs3136229) G→A, PGR (rs1042838) G→T, RAD51L3 (rs4796033) G→A, STK15 (rs2273535) T→A and TFR (rs3817672) A→G.

It is contemplated that any method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.”

It is contemplated that any embodiment discussed in this specification can be implemented with respect to any method or composition of the invention, and vice versa. Furthermore, compositions and kits of the invention can be used to achieve methods of the invention.

Throughout this application, the term “about” is used to indicate that a value includes the inherent variation of error for the device, the method being employed to determine the value, or the variation that exists among the study subjects.

### DESCRIPTION OF ILLUSTRATIVE EMBODIMENTS

Despite considerable progress in cancer therapy, cancer mortality rates continue to be high. Generally, the poor prognosis of many cancer patients derives from the failure to identify the disease at an early stage, i.e., before metastasis has occurred. While not trivial, treatment of organ confined primary tumors is far more likely to be successful than any treatment for advanced, disseminated malignancies.

In order to affect early diagnosis of cancer, at a time when patients still appear healthy, it is necessary to screen large numbers of individuals. However, the costs associated with such testing, and the unnecessary follow-ups occasioned by false positive results, are prohibitive. Thus, it is necessary to find better ways of assessing cancer risk in the general population and concentrating preventative and early detection efforts on those individuals at highest risk.

### I. THE PRESENT INVENTION

In accordance with the present invention, the inventors have identified alleles for Single Nucleotide Polymorphisms (SNPs) and other genetic variations that are associated with varying levels of risk for a diagnosis of breast cancer. A SNP is the smallest unit of genetic variation. It represents a position in a genome where individuals of the same species may have alternative nucleotides present at the same site in their DNA sequences. It could be said that our genes make us human, but our SNPs make us unique individuals. An allele is a particular variant of a gene. For example, some individuals may have the DNA sequence, AAGTCCG, in some arbitrary gene. Other individuals may have the sequence, AAGTTCG, at the same position in the same gene. Notice that these DNA sequences are the same except at the underlined position where some people have a “C” nucleotide while others have a “T” nucleotide. This is the site of a SNP. It is said that some people carry the C allele of this SNP, while others carry the T allele.

Except for those genes on the sex chromosomes and in the mitochondrial genome, there are two copies of every gene in every cell in the body. A child inherits one copy of each gene from each parent. A person could have two C alleles of the fictitious SNP described above. This person would carry the genotype C/C at this SNP. Alternatively, a person could have the genotype T/T at this SNP. As in both of these examples, if someone carries two identical copies of a portion of a potentially variant portion of a gene, they are referred to as homozygous for this gene or portion of a gene. Obviously, some people will carry two different alleles of this gene having the genotype, C/T or T/C, and will be termed heterozygous for this SNP. Lastly, some genetic variation may involve more than one nucleotide position. Common examples of such variation, and ones that are relevant to this invention, are polymorphisms where there have been insertions or deletions of one or more nucleotides in one allele of a gene relative to the alternative allele(s).

In addition to genetic variation, the inventors have examined the interaction between age and genetic variation to better estimate risk of breast cancer. They have also begun to examine ethnic affiliation and family history of cancer as additional variables to better estimate breast cancer risk. Age, gender, ethnic affiliation and family medical history are all examples of personal history measures. Other examples of personal history measures include reproductive history, menstruation history, use of oral contraceptives, body mass index, smoking and alcohol consumption history, and exercise and diet.

In the experiments disclosed herein, the inventors report the examination of alleles of numerous genetic polymorphisms. Polymorphisms were assayed by standard techniques to detect these SNPs including Allele Specific Primer Extension (ASPE), Restriction Fragment Length Polymorphisms (RFLPs) or simple length polymorphisms in gene specific PCR products. All of the polymorphisms examined have been described previously in the peer reviewed scientific literature as having some functional activity or association with disease, usually cancer.

The inventors' hypothesis was that by examining these polymorphisms in very large associative studies one would find certain genotypes and combinations of genotypes that were much more informative for predicting cancer risk than could have been predicted a priori. In fact, it now has been determined that certain genotypes and combinations of genotypes are associated with extraordinary risk of breast cancer. So high is the genetically inherited risk of breast cancer in individuals carrying certain genotypes and combinations of genotypes, that their risk distorts the apparent breast cancer risk in the population at large. Thus, surprisingly, the large majority of women are actually at much less than “average” risk from breast cancer. Such dramatic findings were unexpected even by the inventors when these experiments were designed. These results provide a means of reallocating breast cancer screening and chemoprevention resources to concentrate on a relatively small portion of the total population at highest risk of breast cancer, thus facilitating better patient outcomes at lower overall healthcare costs.

### II. TARGET GENES AND ALLELES

Table 1, below, provides a listing of the genes, the specific genetic polymorphisms examined in the present study, and a literature citation. The letters in parentheses are abbreviations for these polymorphisms that will be used throughout the remainder of this text.

Some of these polymorphisms have been discussed in the literature in depth in perhaps dozens of scientific publications. While the scientific literature suggests that many of these polymorphisms may be associated with very modest changes in cancer risk, or are associated with larger variations in risk within a small subset of the population, many of these polymorphisms are controversial in the scientific literature, with some studies finding no associated change in relative cancer risk. Formally, in genetic terms, these common SNP genotypes individually have low penetrance for the breast cancer phenotype, but when occurring together create complex genotypes with very high penetrance for the breast cancer phenotype. The inventors note that their hypothesis for cancer predisposition is consistent with that of a complex multi-gene phenomenon, as has been discussed by others (Lander and Schork, 1994), and is in agreement with the long-standing observation that cancers in general, and breast cancer in particular, are complex diseases. However, these particular gene combinations have not previously been identified as being associated with risk of breast or any other cancer. The model developed integrates genetic main effects, gene-gene interactions (epistasis) and personal history measures to evaluate risk of developing breast cancer. The main effects that are incorporated into the model were identified in age-stratified logistic regression analyses as significantly associated with breast cancer risk. In a given age group, the collective consideration of 10-16 markers has predictive value that exceeds any single term in other words the whole is greater than any single part. Beyond this non-parametric analyses of candidate genes have identified oligogenic combinations associated with breast cancer risk (WO2003/025141; WO2005/024067). An initial published study examined polymorphisms in ten genes and identified a total of 69 two- and three-gene combinations significantly associated with breast cancer risk (Aston et al., 2005). This represented over thirty times as many significant associations as would be expected by random chance. The odds ratios (ORs) of these oligogenic combinations ranged from 0.5 to 5.9. Current analyses on much larger datasets have identified epistatic interactions that do not overlap with the main effects and they contribute to the predictive power of the integrated model.

### III. SAMPLE COLLECTION AND PROCESSING

A. Sampling

In order to assess the genetic make-up of an individual, it is necessary to obtain a nucleic acid-containing sample. Suitable tissues include almost any nucleic acid containing tissue, but those most convenient include oral tissue or blood. For those DNA specimens isolated from peripheral blood specimens, blood was collected in heparinized syringes or other appropriate vessel following venipuncture with a hypodermic needle. Oral tissue may advantageously be obtained from a mouth rinse. Oral tissue or buccal cells may be collected with oral rinses, e.g., with “Original Mint” flavor Scope™ mouthwash. Typically, a volunteer participant would vigorously swish 10-15 ml of mouthwash in their mouth for 10-15 seconds. The volunteer would then spit the mouthwash into a 50 ml conical centrifuge tube (for example Fisherbrand disposable centrifuge tubes with plug seal caps (catalog #05-539-6)) or other appropriate container.

B. Processing of Nucleic Acids

Genomic DNA was isolated and purified from the samples collected as described below using the PUREGENE™ DNA isolation kit manufactured by Gentra Systems of Minneapolis, Minn. For the peripheral blood specimens, red blood cells were lysed using the RBC lysis solution provided in the kit. After centrifugation at 2000×g for 10 minutes the supernatant was discarded and the resulting cell pellet was lysed in a cell lysis solution. The lysate was digested with RNase A and proteins were precipitated. Finally, the genomic DNA was precipitated with isopropanol followed by washing with 70% ethanol. The resulting purified genomic DNA was resuspended in aqueous solution before gene specific PCR and SNP analysis.

In another embodiment, the inventors isolate the large majority of the DNA specimens from buccal cells obtained through the mouthwash procedure. The following is the standard operating procedure (SOP) used to isolate genomic DNA from buccal cells using the Gentra Systems kit.

Genomic DNA is isolated from individual buccal cell samples. Using Polymerase Chain Reaction (PCR) device, target genomic sequences are amplified. The resulting PCR products are analyzed by gel electrophoresis or by digestion with an appropriate restriction endonuclease followed by gel electrophoresis to obtain a specific genotype for the buccal cell samples.

A number of different materials are used in accordance with the present invention. These include primary solutions used in DNA Extraction (Cell Lysis Solution, Gentra Systems Puregene, and Cat. # D-50K2, 1 Liter; Protein Precipitation Solution, Gentra Systems Puregene, Cat. # D-50K3, 350 ml; DNA Hydration Solution, Gentra Systems Puregene, Cat. # D-500H, 100 ml) and secondary solutions used in DNA Extraction (Proteinase K enzyme, Fisher Biotech, Cat. # BP1700, 100 mg powder; RNase A enzyme, Amresco, Cat. # 0675, 500 mg powder; Glycogen, Fisher Biotech, Cat. # BP676, 5 gm powder, 2-propanol (isopropanol), Fisher Scientific, Cat. # A451, 1 Liter; TE Buffer Solution pH 8.0, Amresco, Cat. # E112, 100 ml; 95% Ethyl Alcohol, AAPER Alcohol & Chemical Co., 5 Liters).

The exemplified DNA extraction procedure involves five basic steps, as discussed below:
Preliminary Procedures. Buccal samples should be processed within 7 days of collection. The DNA is stable in mouthwash at room temperature, but may degrade if left longer than a week before processing.
Cell Lysis and RNase A Treatment. Samples are centrifuged (50 ml centrifuge tube containing the buccal cell sample) at 3000 rpm (or 2000×g) for 10 minutes using a large capacity (holds 20-50 ml or 40-15 ml centrifuge tubes) refrigerated centrifuge. Immediately pour off the supernatant into a waste bottle, leaving behind roughly 100 μl of residual liquid and the buccal cell pellet at the bottom of the 50 ml tube. Be aware that loose pellets will result if samples are left too long after centrifugation before discarding the liquid. Vortex (using a Vortex Genie at high speed) for 5 seconds to resuspend the cells in the residual supernatant. This greatly facilitates cell lysis (below). Pipette (use a pipette aide and a 10 ml pipette) 1.5 ml of Cell Lysis Solution into the 50 ml tube to resuspend the cells, and then vortex for 5 seconds to maximize contact between cells and cell lysis solution. If necessary, new samples may need to be stored longer than a week before finishing the whole DNA extraction process. If so, one needs to process the samples to the point of adding Cell Lysis Solution and store the samples at 4° C. The samples will easily be kept viable for months. Do not store unprocessed samples at 4° C., as this has been shown to prevent the preparation of DNA that produces an easily executed PCR. Using a 20 μl Pipetman and 250 μl pipettes, add 15 μl of Proteinase K (10 mg/ml) enzyme into each sample tube, releasing Proteinase K directly into the cell lysate solution of each tube. No part of the Pipetman should touch sample tube—only the pipette tips. Change pipette tip with each sample tube. Vortex briefly to mix. Incubate the cell lysate in the 50 ml tube at 55° C. for 1 hour. The enzyme will not activate until around 55° C., so make sure incubator is near that temperature before starting. It is permissible to incubate longer if needed, even overnight. Pipette 511 of RNase A (5 mg/ml) enzyme directly into the cell lysate solution of each 50 ml sample tube. This is required because of the relatively small volume of the enzyme. Change pipette tips for every new sample. Mix the sample by inverting the tube gently 25 times, and then incubate in the water bath at 37° C. for 15 minutes.
Protein Precipitation. The sample should be cooled to room temperature. At this point, sample may sit for an hour if needed. Using the pipette aide and 5 ml pipettes, add 0.5 ml of Protein Precipitation Solution to each 50 ml sample tube of cell lysate. Vortex samples for 20 seconds to mix the Protein Precipitation Solution uniformly with the cell lysate. Place 50 ml sample tube in an ice bath for a minimum of 15 minutes, preferably longer. This ensures that the cell protein will form a tight pellet when you centrifuge (next step). Centrifuge at 3000 rpm (2000×g) for 10 minutes, having the centrifuge refrigerated to 4° C. The precipitated proteins should form a tight, white or green pellet (it may appear green if mint mouthwash was used to collect the buccal samples).
DNA Precipitation. While waiting for the centrifuge to finish, prepare enough sterile 15 ml centrifuge tubes to accommodate your samples. Add 5 μl of glycogen (10 mg/ml) to each tube, forming a bead of liquid near the top. Then add 1.5 ml of 100% 2-propanol to each tube. Carefully pour the supernatant containing the DNA into the prepared 15 ml tubes, leaving behind the precipitated protein pellet in the 50 ml tube. If the pellet is loose you may have to pipette the supernatant out, getting as much clear liquid as possible. Pellet may be loose because the sample was not chilled long enough or may need to be centrifuged longer. Nothing but clear greenish liquid should go into the new 15 ml tube. Be careful that the protein pellet does not break loose as you pour. Record on new tube the correct sample number as was on the 50 ml tube. Discard the 50 ml tube. Mix the 15 ml sample tube by inverting gently 50 times. Rough handling may shear DNA strands. Clean white strands clumping together should be observed. Keep at room temperature for at least 5 minutes. Centrifuge at 3000 rpm (2000×g) for 10 minutes. The DNA may or may not be visible as a small white pellet, depending on yield. If the pellet is any other color, the sample has contamination. If there is apparent high yield, it may also point to contamination. Pour off the supernatant into a waste bottle, being careful not to let the DNA dislodge and slide out with the liquid. Invert the open 15 ml sample tubes over a clean absorbent paper towel to drain out remaining liquid. Let sit for 5 minutes. Invert tubes right side back up, put caps back on and set them in holding tray (Styrofoam tray the 15 ml tubes were shipped in) with numbered side facing away. Add 1.5 ml of 70% ethanol to each tube. Invert the tubes several times to wash the DNA pellet. Centrifuge at 3000 rpm (2000×g) for 3 minutes. Carefully pour off the ethanol. Invert the sample tube onto a paper towel and let air dry no longer than 15 minutes before resuspending the DNA using a hydration solution. If the DNA is allowed to dry out completely, it will increase the difficulty of rehydrating it.
DNA Hydration. Depending on the size of the resulting DNA pellet, add between 50-200 μl of DNA Hydration Solution to the 15 ml sample tube. If the tube appears to have no DNA, use 50 μl. If it appears to have some, but not a lot, use 100 μl. With a good-sized pellet, 150-200 μl can be used. This is important because the concentration of DNA affects the results of the PCR experiment, and one does not want to dilute the DNA too much. The optimal concentration of DNA is around 100 ng/μl. Allow the DNA to hydrate by incubating at room temperature overnight or at 65° C. for 1 hour. Tap the tube periodically or place on a rotator to aid in dispersing DNA (this helps if the DNA was allowed to dry out completely, but normally it is not required). For storage, sample should be centrifuged briefly and transferred to a cross-linked or UV radiated 1.5 ml centrifuge tube (that was previously autoclaved). Store genomic DNA sample at 4° C. For long-term storage, store at −20° C.
   While suitable substitute procedures may suffice, following the preceding protocol will ensure the fidelity of the results.

C. cDNA Production

In one aspect of the invention, it may be useful to prepare a cDNA population for subsequent analysis. In typical cDNA production, mRNA molecules with poly(A) tails are potential templates and will each produce, when treated with a reverse transcriptase, a cDNA in the form of a single-stranded molecule bound to the mRNA (cDNA:mRNA hybrid). The cDNA is then converted into double-stranded DNA by DNA polymerases such as DNA Pol I (Klenow fragment). Klenow polymerase is used to avoid degradation of the newly synthesized cDNAs. To produce the template for the polymerase, the mRNA must be removed from the cDNA:mRNA hybrid. This is achieved either by boiling or by alkaline treatment (see lecture notes on the properties of nucleic acids). The resulting single-stranded cDNA is used as the template to produce the second DNA strand. As with other polymerases, a double-stranded primer sequence is needed and this is fortuitously provided during the reverse transcriptase synthesis, which produces a short complementary tail at the 5′ end of the cDNA. This tail loops back onto the ss cDNA template (the so-called “hairpin loop”) and provides the primer for the polymerase to start the synthesis of the new DNA strand producing a double stranded cDNA (ds cDNA). A consequence of this method of cDNA synthesis is that the two complementary cDNA strands are covalently joined through the hairpin loop. The hairpin loop is removed by use of a single strand specific nuclease (e.g., S1 nuclease from Aspergillus oryzae).

Kits for cDNA synthesis (SMART RACE cDNA Amplification Kit; Clontech, Palo Alto, Calif.). It also is possible to couple cDNA with PCR™, into what is referred to as RT-PCR™. PCR™ is discussed in greater detail below.

### IV. DETECTION METHODS

Once the sample has been properly processed, detection of sequence variation is required. Perhaps the most direct method is to actually determine the sequence of either genomic DNA or cDNA and compare these to the known alleles. This can be a fairly expensive and time-consuming process. Nevertheless, this is the lead technology of numerous bioinformatics companies with interests in SNPs including such firms as Celera, Curagen, Incyte, Variagenics and Genaissance, and the technology is available to do fairly high volume sequencing of samples. A variation on the direct sequence determination method is the Gene Chip™ method as advanced by Affymetrix. Such chips are discussed in greater detail below.

Alternatively, more clinically robust and less expensive ways of detecting DNA sequence variation are being developed. For example, Perkin Elmer adapted its TAQman™ Assay to detect sequence variation several years ago.

Orchid BioSciences has a method called SNP-IT™ (SNP-Identification Technology) that uses primer extension with labeled nucleotide analogs to determine which nucleotide occurs at the position immediately 3′ of an oligonucleotide probe.

Sequenom uses a hybridization capture technology plus MALDI-TOF (Matrix Assisted Laser Desorption/Ionization-Time-of-Flight mass spectrometry) to detect sequence variation with their MassARAY™ system.

Promega has the READIT™ SNP/Genotyping System (U.S. Pat. No. 6,159,693). In this method, DNA or RNA probes are hybridized to target nucleic acid sequences. Probes that are complementary to the target sequence at each base are depolymerized with a proprietary mixture of enzymes, while probes which differ from the target at the interrogation position remain intact. The method uses pyrophosphorylation chemistry in combination with luciferase detection to provide a highly sensitive and adaptable SNP scoring system.

Third Wave Technologies has the Invader OS™ method that uses their proprietary Cleavase® enzymes, which recognize and cut only the specific structure formed during the Invader process The Invader OS relies on linear amplification of the signal generated by the Invader process, rather than on exponential amplification of the target. The Invader OS assay does not utilize PCR in any part of the assay.

There are a number of forensic DNA testing labs and many research labs that use gene-specific PCR, followed by restriction endonuclease digestion and gel electrophoresis (or other size separation technology) to detect RFLPs in much the same way that the inventors have. The point is that, how one detects sequence variation (SNPs) is not important in the estimation of cancer risk. The key is the genes and polymorphisms that one examines.

As an alternative SNP detection technology to RFLP, genotypes were determined by Allele Specific Primer Extension (ASPE) coupled to a microsphere-based technical readout. Many accounts of SNP genotyping using microsphere-based methods have been published in the scientific literature. The method is being used as an alternative to RFLP and closely resembles that of Ye et al. (2001). This technology was implemented through the Luminex™-100 microsphere detection platform (Luminex, Austin, Tex.) using oligonucleotide labeled microspheres purchased from MiraiBio, Inc. (Alameda, Calif.).

The following materials and methodologies relate to the present invention, and are therefore described in some detail.

A. Chips

As discussed above, one convenient approach to detecting variation involves the use of nucleic acid arrays placed on chips. This technology has been widely exploited by companies such as Affymetrix, and a large number of patented technologies are available. Specifically contemplated are chip-based DNA technologies such as those described by Hacia et al. (1996) and Shoemaker et al. (1996). These techniques involve quantitative methods for analyzing large numbers of sequences rapidly and accurately. The technology capitalizes on the complementary binding properties of single stranded DNA to screen DNA samples by hybridization. Pease et al. (1994); Fodor et al. (1991).

Basically, a DNA array or gene chip consists of a solid substrate to which an array of single-stranded DNA molecules has been attached. For screening, the chip or array is contacted with a single-stranded DNA sample, which is allowed to hybridize under stringent conditions. The chip or array is then scanned to determine which probes have hybridized. In a particular embodiment of the instant invention, a gene chip or DNA array would comprise probes specific for chromosomal changes evidencing the predisposition towards the development of a neoplastic or preneoplastic phenotype. In the context of this embodiment, such probes could include PCR products amplified from patient DNA synthesized oligonucleotides, cDNA, genomic DNA, yeast artificial chromosomes (YACs), bacterial artificial chromosomes (BACs), chromosomal markers or other constructs a person of ordinary skill would recognize as adequate to demonstrate a genetic change.

A variety of gene chip or DNA array formats are described in the art, for example U.S. Pat. Nos. 5,861,242 and 5,578,832, which are expressly incorporated herein by reference. A means for applying the disclosed methods to the construction of such a chip or array would be clear to one of ordinary skill in the art. In brief, the basic structure of a gene chip or array comprises: (1) an excitation source; (2) an array of probes; (3) a sampling element; (4) a detector; and (5) a signal amplification/treatment system. A chip may also include a support for immobilizing the probe.

In particular embodiments, a target nucleic acid may be tagged or labeled with a substance that emits a detectable signal, for example, luminescence. The target nucleic acid may be immobilized onto the integrated microchip that also supports a phototransducer and related detection circuitry. Alternatively, a gene probe may be immobilized onto a membrane or filter, which is then attached to the microchip or to the detector surface itself. In a further embodiment, the immobilized probe may be tagged or labeled with a substance that emits a detectable or altered signal when combined with the target nucleic acid. The tagged or labeled species may be fluorescent, phosphorescent, or otherwise luminescent, or it may emit Raman energy or it may absorb energy. When the probes selectively bind to a targeted species, a signal is generated that is detected by the chip. The signal may then be processed in several ways, depending on the nature of the signal.

The DNA probes may be directly or indirectly immobilized onto a transducer detection surface to ensure optimal contact and maximum detection. The ability to directly synthesize on or attach polynucleotide probes to solid substrates is well known in the art. See U.S. Pat. Nos. 5,837,832 and 5,837,860, both of which are expressly incorporated by reference. A variety of methods have been utilized to either permanently or removably attach the probes to the substrate. Exemplary methods include: the immobilization of biotinylated nucleic acid molecules to avidin/streptavidin coated supports (Holmstrom, 1993), the direct covalent attachment of short, 5′-phosphorylated primers to chemically modified polystyrene plates (Rasmussen et al., 1991), or the precoating of the polystyrene or glass solid phases with poly-L-Lys or poly L-Lys, Phe, followed by the covalent attachment of either amino- or sulfhydryl-modified oligonucleotides using bi-functional crosslinking reagents (Running et al., 1990; Newton et al., 1993). When immobilized onto a substrate, the probes are stabilized and therefore may be used repeatedly. In general terms, hybridization is performed on an immobilized nucleic acid target or a probe molecule is attached to a solid surface such as nitrocellulose, nylon membrane or glass. Numerous other matrix materials may be used, including reinforced nitrocellulose membrane, activated quartz, activated glass, polyvinylidene difluoride (PVDF) membrane, polystyrene substrates, polyacrylamide-based substrate, other polymers such as poly(vinyl chloride), poly(methyl methacrylate), poly(dimethyl siloxane), and photopolymers (which contain photoreactive species such as nitrenes, carbenes and ketyl radicals) capable of forming covalent links with target molecules.

Binding of the probe to a selected support may be accomplished by any of several means. For example, DNA is commonly bound to glass by first silanizing the glass surface, then activating with carbodimide or glutaraldehyde. Alternative procedures may use reagents such as 3-glycidoxypropyltrimethoxysilane (GOP) or aminopropyltrimethoxysilane (APTS) with DNA linked via amino linkers incorporated either at the 3′ or 5′ end of the molecule during DNA synthesis. DNA may be bound directly to membranes using ultraviolet radiation. With nitrocellose membranes, the DNA probes are spotted onto the membranes. A UV light source (Stratalinker™, Stratagene, La Jolla, Calif.) is used to irradiate DNA spots and induce cross-linking. An alternative method for cross-linking involves baking the spotted membranes at 80° C. for two hours in vacuum.

Specific DNA probes may first be immobilized onto a membrane and then attached to a membrane in contact with a transducer detection surface. This method avoids binding the probe onto the transducer and may be desirable for large-scale production. Membranes particularly suitable for this application include nitrocellulose membrane (e.g., from BioRad, Hercules, Calif.) or polyvinylidene difluoride (PVDF) (BioRad, Hercules, Calif.) or nylon membrane (Zeta-Probe, BioRad) or polystyrene base substrates (DNA.BIND™ Costar, Cambridge, Mass.).

B. Nucleic Acid Amplification Procedures

A useful technique in working with nucleic acids involves amplification. Amplifications are usually template-dependent, meaning that they rely on the existence of a template strand to make additional copies of the template. Primers, short nucleic acids that are capable of priming the synthesis of a nascent nucleic acid in a template-dependent process, are hybridized to the template strand. Typically, primers are from ten to thirty base pairs in length, but longer sequences can be employed. Primers may be provided in double-stranded and/or single-stranded form, although the single-stranded form generally is preferred.

Often, pairs of primers are designed to selectively hybridize to distinct regions of a template nucleic acid, and are contacted with the template DNA ‘under conditions that permit selective hybridization. Depending upon the desired application, high stringency hybridization conditions may be selected that will only allow hybridization to sequences that are completely complementary to the primers. In other embodiments, hybridization may occur under reduced stringency to allow for amplification of nucleic acids containing one or more mismatches with the primer sequences. Once hybridized, the template-primer complex is contacted with one or more enzymes that facilitate template-dependent nucleic acid synthesis. Multiple rounds of amplification, also referred to as “cycles,” are conducted until a sufficient amount of amplification product is produced.

PCR: A number of template dependent processes are available to amplify the oligonucleotide sequences present in a given template sample. One of the best known amplification methods is the polymerase chain reaction (referred to as PCR™) which is described in detail in U.S. Pat. Nos. 4,683,195, 4,683,202 and 4,800,159, and in Innis et al., 1988, each of which is incorporated herein by reference in their entirety. In PCR™, pairs of primers that selectively hybridize to nucleic acids are used under conditions that permit selective hybridization. The term primer, as used herein, encompasses any nucleic acid that is capable of priming the synthesis of a nascent nucleic acid in a template-dependent process. Primers may be provided in double-stranded or single-stranded form, although the single-stranded form is preferred.

The primers are used in any one of a number of template dependent processes to amplify the target gene sequences present in a given template sample. One of the best known amplification methods is PCR™ which is described in detail in U.S. Pat. Nos. 4,683,195, 4,683,202 and 4,800,159, each incorporated herein by reference.

In PCR™, two primer sequences are prepared which are complementary to regions on opposite complementary strands of the target-gene(s) sequence. The primers will hybridize to form a nucleic-acid:primer complex if the target-gene(s) sequence is present in a sample. An excess of deoxyribonucleoside triphosphates is added to a reaction mixture along with a DNA polymerase, e.g., Taq polymerase that facilitates template-dependent nucleic acid synthesis.

If the target-gene(s) sequence:primer complex has been formed, the polymerase will cause the primers to be extended along the target-gene(s) sequence by adding on nucleotides. By raising and lowering the temperature of the reaction mixture, the extended primers will dissociate from the target-gene(s) to form reaction products, excess primers will bind to the target-gene(s) and to the reaction products and the process is repeated. These multiple rounds of amplification, referred to as “cycles”, are conducted until a sufficient amount of amplification product is produced.

A reverse transcriptase PCR™ amplification procedure may be performed in order to quantify the amount of mRNA amplified. Methods of reverse transcribing RNA into cDNA are well known and described in Sambrook et al., 2001. Alternative methods for reverse transcription utilize thermostable DNA polymerases. These methods are described in WO 90/07641, filed Dec. 21, 1990.

LCR: Another method for amplification is the ligase chain reaction (“LCR”), disclosed in European Patent Application No. 320,308, incorporated herein by reference. In LCR, two complementary probe pairs are prepared, and in the presence of the target sequence, each pair will bind to opposite complementary strands of the target such that they abut. In the presence of a ligase, the two probe pairs will link to form a single unit. By temperature cycling, as in PCR™, bound ligated units dissociate from the target and then serve as “target sequences” for ligation of excess probe pairs. U.S. Pat. No. 4,883,750, incorporated herein by reference, describes a method similar to LCR for binding probe pairs to a target sequence.

Qbeta Replicase: Qbeta Replicase, described in PCT Patent Application No. PCT/US87/00880, also may be used as still another amplification method in the present invention. In this method, a replicative sequence of RNA, which has a region complementary to that of a target, is added to a sample in the presence of an RNA polymerase. The polymerase will copy the replicative sequence, which can then be detected.

Isothermal Amplification: An isothermal amplification method, in which restriction endonucleases and ligases are used to achieve the amplification of target molecules that contain nucleotide 5′-[α-thio]-triphosphates in one strand of a restriction site also may be useful in the amplification of nucleic acids in the present invention. Such an amplification method is described by Walker et al. 1992, incorporated herein by reference.

Strand Displacement Amplification: Strand Displacement Amplification (SDA) is another method of carrying out isothermal amplification of nucleic acids which involves multiple rounds of strand displacement and synthesis, i.e., nick translation. A similar method, called Repair Chain Reaction (RCR), involves annealing several probes throughout a region targeted for amplification, followed by a repair reaction in which only two of the four bases are present. The other two bases can be added as biotinylated derivatives for easy detection. A similar approach is used in SDA.

Cyclic Probe Reaction: Target specific sequences can also be detected using a cyclic probe reaction (CPR). In CPR, a probe having 3′ and 5′ sequences of non-specific DNA and a middle sequence of specific RNA is hybridized to DNA, which is present in a sample. Upon hybridization, the reaction is treated with RNase H, and the products of the probe identified as distinctive products, which are released after digestion. The original template is annealed to another cycling probe and the reaction is repeated.

Transcription-Based Amplification: Other nucleic acid amplification procedures include transcription-based amplification systems (TAS), including nucleic acid sequence based amplification (NASBA) and 3SR, Kwoh et al. (1989); PCT Application WO 88/10315 (each incorporated herein by reference).

In NASBA, the nucleic acids can be prepared for amplification by standard phenol/chloroform extraction, heat denaturation of a clinical sample, treatment with lysis buffer and mini-spin columns for isolation of DNA and RNA or guanidinium chloride extraction of RNA. These amplification techniques involve annealing a primer, which has target specific sequences. Following polymerization, DNA/RNA hybrids are digested with RNase H while double-stranded DNA molecules are heat denatured again. In either case the single stranded DNA is made fully double stranded by addition of second target specific primer, followed by polymerization. The double-stranded DNA molecules are then multiply transcribed by a polymerase such as T7 or SP6. In an isothermal cyclic reaction, the RNA's are reverse transcribed into double stranded DNA, and transcribed once against with a polymerase such as T7 or SP6. The resulting products, whether truncated or complete, indicate target specific sequences.

Other Amplification Methods: Other amplification methods, as described in British Patent Application No. GB 2,202,328, and in PCT Application No. PCT/US89/01025, each incorporated herein by reference, may be used in accordance with the present invention. In the former application, “modified” primers are used in a PCR™ like, template and enzyme dependent synthesis. The primers may be modified by labeling with a capture moiety (e.g., biotin) and/or a detector moiety (e.g., enzyme). In the latter application, an excess of labeled probes are added to a sample. In the presence of the target sequence, the probe binds and is cleaved catalytically. After cleavage, the target sequence is released intact to be bound by excess probe. Cleavage of the labeled probe signals the presence of the target sequence.

Davey et al., European Patent Application No. 329 822 (incorporated herein by reference) disclose a nucleic acid amplification process involving cyclically synthesizing single-stranded RNA (“ssRNA”), ssDNA, and double-stranded DNA (dsDNA), which may be used in accordance with the present invention.

The ssRNA is a first template for a first primer oligonucleotide, which is elongated by reverse transcriptase (RNA-dependent DNA polymerase). The RNA is then removed from the resulting DNA:RNA duplex by the action of ribonuclease H(RNase H, an RNase specific for RNA in duplex with either DNA or RNA). The resultant ssDNA is a second template for a second primer, which also includes the sequences of an RNA polymerase promoter (exemplified by T7 RNA polymerase) 5′ to its homology to the template. This primer is then extended by DNA polymerase (exemplified by the large “Klenow” fragment of E. Coli DNA polymerase I), resulting in a double-stranded DNA (“dsDNA”) molecule, having a sequence identical to that of the original RNA between the primers and having additionally, at one end, a promoter sequence. This promoter sequence can be used by the appropriate RNA polymerase to make many RNA copies of the DNA. These copies can then re-enter the cycle leading to very swift amplification. With proper choice of enzymes, this amplification can be done isothermally without addition of enzymes at each cycle. Because of the cyclical nature of this process, the starting sequence can be chosen to be in the form of either DNA or RNA.

Miller et al., PCT Patent Application WO 89/06700 (incorporated herein by reference) disclose a nucleic acid sequence amplification scheme based on the hybridization of a promoter/primer sequence to a target single-stranded DNA (“ssDNA”) followed by transcription of many RNA copies of the sequence. This scheme is not cyclic, i.e., new templates are not produced from the resultant RNA transcripts.

Other suitable amplification methods include “race” and “one-sided PCR™” (Frohman, 1990; Ohara et al., 1989, each herein incorporated by reference). Methods based on ligation of two (or more) oligonucleotides in the presence of nucleic acid having the sequence of the resulting “di-oligonucleotide,” thereby amplifying the di-oligonucleotide, also may be used in the amplification step of the present invention, Wu et al., 1989, incorporated herein by reference).

C. Methods for Nucleic Acid Separation

It may be desirable to separate nucleic acid products from other materials, such as template and excess primer. In one embodiment, amplification products are separated by agarose, agarose-acrylamide or polyacrylamide gel electrophoresis using standard methods (Sambrook et al., 2001). Separated amplification products may be cut out and eluted from the gel for further manipulation. Using low melting point agarose gels, the separated band may be removed by heating the gel, followed by extraction of the nucleic acid.

Separation of nucleic acids may also be effected by chromatographic techniques known in art. There are many kinds of chromatography which may be used in the practice of the present invention, including adsorption, partition, ion-exchange, hydroxylapatite, molecular sieve, reverse-phase, column, paper, thin-layer, and gas chromatography as well as HPLC.

In certain embodiments, the amplification products are visualized. A typical visualization method involves staining of a gel with ethidium bromide and visualization of bands under UV light. Alternatively, if the amplification products are integrally labeled with radio- or fluorometrically-labeled nucleotides, the separated amplification products can be exposed to x-ray film or visualized with light exhibiting the appropriate excitatory spectra.

### V. PERSONAL HISTORY MEASURES

In addition to use of the genetic analysis disclosed herein, the present invention makes use of additional factors in gauging an individual's risk for developing cancer. In particular, one will examine multiple factors including age, ethnicity, reproductive history, menstruation history, use of oral contraceptives, body mass index, alcohol consumption history, smoking history, exercise history, and diet to improve the predictive accuracy of the present methods. A history of cancer in a relative, and the age at which the relative was diagnosed with cancer, are also important personal history measures. The inclusion of personal history measures with genetic data in an analysis to predict a phenotype, cancer in this case, is grounded in the realization that almost all phenotypes are derived from a dynamic interaction between an individual's genes and the environment in which these genes act. For example, fair skin may predispose an individual to melanoma but only if the individual is exposed to prolonged unshielded exposure to the sun's ultraviolet radiation. The inventors include personal history measures in their analysis because they are possible modifiers of the penetrance of the cancer phenotype for any genotype examined. Those skilled in the art will realize that the personal history measures listed in this paragraph are unlikely to be the only such environmental factors that affect the penetrance of the cancer phenotype.

### VI. KITS

The present invention also contemplates the preparation of kits for use in accordance with the present invention. Suitable kits include various reagents for use in accordance with the present invention in suitable containers and packaging materials, including tubes, vials, and shrink-wrapped and blow-molded packages.

Materials suitable for inclusion in a kit in accordance with the present invention comprise one or more of the following:
gene specific PCR primer pairs (oligonucleotides) that anneal to DNA or cDNA sequence domains that flank the genetic polymorphisms of interest;
reagents capable of amplifying a specific sequence domain in either genomic DNA or cDNA without the requirement of performing PCR;
reagents required to discriminate between the various possible alleles in the sequence domains amplified by PCR or non-PCR amplification (e.g., restriction endonucleases, oligonucleotides that anneal preferentially to one allele of the polymorphism, including those modified to contain enzymes or fluorescent chemical groups that amplify the signal from the oligonucleotide and make discrimination of alleles most robust);
reagents required to physically separate products derived from the various alleles (e.g., agarose or polyacrylamide and a buffer to be used in electrophoresis, HPLC columns, SSCP gels, formamide gels or a matrix support for MALDI-TOF).

### VII. CANCER PROPHYLAXIS

In one aspect of the invention, there is an improved ability to identify candidates for prophylactic cancer treatments due to being identified as at a high genetic risk of developing breast cancer. The primary drugs for use in breast cancer prophylaxis are tamoxifen and raloxifene, discussed further below. However, those skilled in the art will realize that there are other chemopreventative drugs currently under development. The disclosed invention is expected to facilitate more appropriate and effective application of these new drugs also when and if they become commercially available.

A. Tamoxifen

Tamoxifen (NOLVADEX®) a nonsteroidal anti-estrogen, is provided as tamoxifen citrate. Tamoxifen citrate tablets are available as 10 mg or 20 mg tablets. Each 10 mg tablet contains 15.2 mg of tamoxifen citrate, which is equivalent to 10 mg of tamoxifen. Inactive ingredients include carboxymethylcellulose calcium, magnesium stearate, mannitol and starch. Tamoxifen citrate is the trans-isomer of a triphenylethylene derivative. The chemical name is (Z)₂-[4-(1,2-diphenyl-1-butenyl)phenoxy]-N,N-dimethylethanamine 2-hydroxy-1,2,3-propanetricarboxylate (1:1). Tamoxifen citrate has a molecular weight of 563.62, the pKa′ is 8.85, the equilibrium solubility in water at 37° C. is 0.5 mg/mL and in 0.02 N HCl at 37° C., it is 0.2 mg/mL.

Tamoxifen citrate has potent antiestrogenic properties in animal test systems. While the precise mechanism of action is unknown, the antiestrogenic effects may be related to its ability to compete with estrogen for binding sites in target tissues such as breast. Tamoxifen inhibits the induction of rat mammary carcinoma induced by dimethylbenzanthracene (DMBA) and causes the regression of DMBA-induced tumors in situ in rats. In this model, tamoxifen appears to exert its anti-tumor effects by binding the estrogen receptors.

Tamoxifen is extensively metabolized after oral administration. Studies in women receiving 20 mg of radiolabeled (¹⁴C) tamoxifen have shown that approximately 65% of the administered dose is excreted from the body over a period of 2 weeks (mostly by fecal route). N-desmethyl tamoxifen is the major metabolite found in patients' plasma. The biological activity of N-desmethyl tamoxifen appears to be similar to that of tamoxifen. 4-hydroxytamoxifen, as well as a side chain primary alcohol derivative of tamoxifen, have been identified as minor metabolites in plasma.

Following a single oral dose of 20 mg, an average peak plasma concentration of 40 ng/mL (range 35 to 45 ng/mL) occurred approximately 5 hours after dosing. The decline in plasma concentrations of tamoxifen is biphasic, with a terminal elimination half-life of about 5 to 7 days. The average peak plasma concentration of N-desmethyl tamoxifen is 15 ng/mL (range 10 to 20 ng/mL). Chronic administration of 10 mg tamoxifen given twice daily for 3 months to patients results in average steady-state plasma concentrations of 120 ng/mL (range 67-183 ng/mL) for tamoxifen and 336 ng/mL (range 148-654 ng/mL) for N-desmethyl tamoxifen. The average steady-state plasma concentrations of tamoxifen and N-desmethyl tamoxifen after administration of 20 mg tamoxifen once daily for 3 months are 122 ng/mL (range 71-183 ng/mL) and 353 ng/mL (range 152-706 ng/mL), respectively. After initiation of therapy, steady state concentrations for tamoxifen are achieved in about 4 weeks and steady state concentrations for N-desmethyl tamoxifen are achieved in about 8 weeks, suggesting a half-life of approximately 14 days for this metabolite.

For patients with breast cancer, the recommended daily dose is 20-40 mg. Dosages greater than 20 mg per day should be given in divided doses (morning and evening). Prophylactic doses may be lower, however.

B. Raloxifene

Raloxifene hydrochloride (EVISTA®) is a selective estrogen receptor modulator (SERM) that belongs to the benzothiophene class of compounds. The chemical designation is methanone, [6-hydroxy-2-(4-hydroxyphenyl)benzo[b]thien-3-yl]-[4-[2-(1-piperidinyl)ethoxy]phenyl]-hydrochloride. Raloxifene hydrochloride (HCl) has the empirical formula C₂₈H₂₇NO₄S.HCl, which corresponds to a molecular weight of 510.05. Raloxifene HCl is an off-white to pale-yellow solid that is very slightly soluble in water.

Raloxifene HCl is supplied in a tablet dosage form for oral administration. Each tablet contains 60 mg of raloxifene HCl, which is the molar equivalent of 55.71 mg of free base. Inactive ingredients include anhydrous lactose, carnuba wax, crospovidone, FD& C Blue No. 2 aluminum lake, hydroxypropyl methylcellulose, lactose monohydrate, magnesium stearate, modified pharmaceutical glaze, polyethylene glycol, polysorbate 80, povidone, propylene glycol, and titanium dioxide.

Raloxifene's biological actions, like those of estrogen, are mediated through binding to estrogen receptors. Preclinical data demonstrate that raloxifene is an estrogen antagonist in uterine and breast tissues. Preliminary clinical data (through 30 months) suggest EVISTA® lacks estrogen-like effects on uterus and breast tissue.

Raloxifene is absorbed rapidly after oral administration. Approximately 60% of an oral dose is absorbed, but presystemic glucuronide conjugation is extensive. Absolute bioavailability of raloxifene is 2.0%. The time to reach average maximum plasma concentration and bioavailability are functions of systemic interconversion and enterohepatic cycling of raloxifene and its glucuronide metabolites.

Following oral administration of single doses ranging from 30 to 150 mg of raloxifene HCl, the apparent volume of distribution is 2.348 L/kg and is not dose dependent. Biotransformation and disposition of raloxifene in humans have been determined following oral administration of ¹⁴C-labeled raloxifene. Raloxifene undergoes extensive first-pass metabolism to the glucuronide conjugates: raloxifene-4′-glucuronide, raloxifene-6-glucuronide, and raloxifene-6, 4′-diglucuronide. No other metabolites have been detected, providing strong evidence that raloxifene is not metabolized by cytochrome P450 pathways. Unconjugated raloxifene comprises less than 1% of the total radiolabeled material in plasma. The terminal log-linear portions of the plasma concentration curves for raloxifene and the glucuronides are generally parallel. This is consistent with interconversion of raloxifene and the glucuronide metabolites.

Following intravenous administration, raloxifene is cleared at a rate approximating hepatic blood flow. Apparent oral clearance is 44.1 L/kg per hour. Raloxifene and its glucuronide conjugates are interconverted by reversible systemic metabolism and enterohepatic cycling, thereby prolonging its plasma elimination half-life to 27.7 hours after oral dosing. Results from single oral doses of raloxifene predict multiple-dose pharmacokinetics. Following chronic dosing, clearance ranges from 40 to 60 L/kg per hour. Increasing doses of raloxifene HCl (ranging from 30 to 150 mg) result in slightly less than a proportional increase in the area under the plasma time concentration curve (AUC). Raloxifene is primarily excreted in feces, and less than 0.2% is excreted unchanged in urine. Less than 6% of the raloxifene dose is eliminated in urine as glucuronide conjugates.

The recommended dosage is one 60 mg tablet daily, which may be administered any time of day without regard to meals. Supplemental calcium is recommended if dietary intake is inadequate.

C. STAR

More than 400 centers across the U.S., Canada and Puerto Rico are currently participating in a clinical trial for tamoxifen and raloxifene, known as STAR. It is one of the largest breast cancer prevention trials ever undertaken. STAR is also the first trial to compare a drug proven to reduce the chance of developing breast cancer with another drug that has the potential to reduce breast cancer risk. All participants receive one or the other drug for five years. At least 22,000 postmenopausal women at high-risk of breast cancer will participate in STAR. All races and ethnic groups are encouraged to participate in STAR.

Tamoxifen (NOLVADEX®) was proven in the Breast Cancer Prevention Trial to reduce breast cancer incidence by 49 percent in women at increased risk of the disease. The U.S. Food and Drug Administration (FDA) approved the use of tamoxifen to reduce the incidence of breast cancer in women at increased risk of the disease in October 1998. Tamoxifen has been approved by the FDA to treat women with breast cancer for more than 20 years and has been in clinical trials for about 30 years.

Raloxifene (trade name EVISTA®) was shown to reduce the incidence of breast cancer in a large study of its use to prevent and treat osteoporosis. This drug was approved by the FDA to prevent osteoporosis in postmenopausal women in December 1997 and has been under study for about five years.

The study is a randomized double-blinded clinical trial to compare the effectiveness of raloxifene with that of tamoxifen in preventing breast cancer in postmenopausal women. Women must be at least 35 years old, have gone no more than one year since undergoing mammography with no evidence of cancer, have no previous mastectomy to prevent breast cancer, have no previous invasive breast cancer or intraductal carcinoma in situ, have not had hormone therapy in at least three months, and have no previous radiation therapy to the breast.

Patients were randomly assigned to one of two groups. Patients in group one received raloxifene plus a placebo by mouth once a day. Patients in group two received tamoxifen plus a placebo by mouth once a day. Treatment will continue for 5 years. Quality of life will be assessed at the beginning of the study and then every 6 months for 5 years. Patients will then receive follow-up evaluations once a year. The STAR trial study results were recently released and a 50% reduction in invasive breast cancer incidence was observed for both raloxifene and tamoxifen (www.cancer.gov/star).

### VIII. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Methods

Study Description. The sample set utilized in the construction and initial validation of this model utilized over 5000 Caucasian women consisting of ˜1791 breast cancer cases and ˜3449 cancer-free controls. Approximately half of the participants were recruited from the greater Oklahoma City metropolitan area from 1996 to 2005. The remainder of the participants was recruited in roughly equal numbers from four other distinct geographic areas (Seattle, San Diego, Kansas City and Orlando/Central Florida) from 2003-2005. Cases were defined as women with a self-reported diagnosis of breast cancer and were identified primarily in mammography centers and oncology practices. Controls were women who had never been diagnosed with any cancer and were recruited primarily from the same mammography facilities and general practice clinics in the same medical complex.

Participants completed a questionnaire concerning personal medical/health history and family history of cancer and were assigned anonymous ID codes that served as the sole identifier of questionnaires and biological samples. The sampling method used for the majority of participants was buccal cells collected in commercial mouthwash. Some participants (˜10% of the total) provided blood samples or both blood and mouthwash. For those individuals that provided both blood and buccal samples, the genotyping results were identical from both sources.

Gene polymorphisms. DNAs from the entire sample set were genotyped for 117 common, functional polymorphisms selected from 87 distinct candidate genes (Table 1). Candidate SNPs were selected by criteria that favored those SNPs having a functionally demonstrated and/or predicted physiological consequence as a result of non-synonymous amino acid substitutions, alterations in enzymatic activity or alterations in mRNA transcription rates or stability. Several criteria were utilized for the selection of candidate genes: (1) either known to, or likely to, alter functional activity of the gene or the protein encoded by the gene (most of these polymorphisms have been directly associated with enzymatic and/or physiological alterations and, thus, are not likely to be simply markers in linkage disequilibrium with the causative polymorphisms); (2) demonstrated role in major pathways that influence breast or other cancer development; (3) previously described to be associated with increased or decreased risk of breast and/or other cancers; (4) reasonable allele frequency in the general population.

Genotyping. Genomic DNA was isolated using the Gentra PureGene™ DNA purification kit (Gentra, Minneapolis, Minn.) and stored frozen (−80° C.). Purified genomic DNA was amplified by multiplex PCR performed in an Eppendorf Mastercycler using HotStarTaq™ DNA polymerase (QIAGEN, Inc. Valencia, Calif.). Annealing and extension temperatures were optimized for each multiplex primer set. The primer sequences and specific genotyping conditions are available from the inventors upon request. All of the genotyping assays are currently performed using microbead-based allele-specific primer extension (ASPE) followed by analysis on the Luminex 100™ (Luminex, Inc. Austin, Tex.). All ASPE assays had reproducibility rates >99.4%. Over 90% of the samples were genotyped using the Luminex technology; some samples were genotyped by PCR-RFLP for some of the variants. The RFLP assays had reproducibility rates of >98%. For all assays, 5% or more of the specimens were genotyped more than once to confirm the internal reproducibility. During all genotyping, operators were blinded to the case-control status of the specimen.

Statistical Analysis: A full range of analyses were performed on both genetic and clinical data, including testing Hardy-Weinberg equilibrium, chi-square test on genotypic associations with case/control status, evaluation of attributable risks, logistic regression analysis, and estimation of predictive probability.

Hardy-Weinberg (HW) equilibrium test. The genotype frequencies in the general population are expected to be at HW equilibrium. Hence, we tested HW equlibrium for genotypes in controls as part of quality control. For any given gene, we compute observed genotype frequencies (f0, f1, f2) for homozygous with common allele, heterozygous, and homozygous with rare allele. From observed genotype frequencies, we computed their allelic frequencies, which can then be used for expected genotype frequencies under HW equilibrium. Using the goodness-of-fit Ω2 test, we determined if the observed genotype frequencies deviate from those expected under HW equilibrium.

Association Analysis. The primary analytic goal was to assess disease associations with genetic and clinical variables. When dealing with a single genotype or single clinical categorical variable, the inventors used the contingency table analysis method to assess the disease association via Ω2-test statistics. In these analyses, the inventors also computed odds ratios (OR) to quantify the magnitudes of associations. In general, however, the inventors used the logistic regression model to assess disease associations with multiple genotypes, their interactions and clinical variables.

Calculation of Individualized Risk Probability. Following the multivariate logistic regression analysis, log odds ratios for the Gail score and all individual SNP genotypes were estimated. Following the methodology described by Gail et al (1989), their attributable risks were computed. Then, by multiplying their compliment to the breast cancer incidence, obtained from SEER (seer.cancer.gov), the inventors obtained the baseline hazard rate for breast cancer, denoted as h₁(t,X)=h_{baseline}(t)RR(t,X), where X denotes combined clinical and genetic variables. To account for competing risks the mortality hazard rate, obtained from the Census and denoted as h₂(t), was utilized. Then, the probability of being diagnosed with breast cancer was computed as

$$Pr ( a , τ , X ) = \frac{{\int }_{a}^{a + τ} {h}_{1} ( u , X ) exp [ - {\int }_{0}^{u} \{ {h}_{1} ( t , X ) + {h}_{2} ( t ) \} ⅆ t ] ⅆ u}{exp [ - {\int }_{0}^{a} \{ {h}_{1} ( t , X ) + {h}_{2} ( t ) \} ⅆ t ]} ,$$

where a is the current age, τ is the age interval in the future, and the integration is over the range specified in the integrands (Gail et al., 1989). Using the above formula, those probabilities were computed for the next five years and lifetime (from now till 90 years old), as well as age intervals from 30-44, 45-55 and 55-69, likely to represent pre-, peri- and post-menopause intervals. The scarcity of individuals over age 70 enrolled in these studies led us to use age 69 as the upper age for analysis.

Model Building. A major challenge was the selection of relevant SNPs that added discriminatory accuracy to the final predictive models without being penalized excessively by multiple comparisons. Towards this objective, the inventors used the following model building and validation strategy. First, the entire data set was randomly assigned into the training set (known as T1 data set throughout the model building exercise) consisting of 75% of all cases and controls. The remaining 25% of cases and controls were used as the validation data set, known as V1 data set that was preserved throughout the validation process. During the training process, the inventors systematically evaluated HW equilibrium for all individual markers, genotypic associations with case/control status, and attributable risks via univariate analysis of one SNP genotype a time. Similarly, the inventors performed tests on linkage-equilibrium on pairwise SNPs, examined epistatic interactions, and evaluated their associations with case/control status. Individual SNPs or their interactions were selected as terms in the final models, only if their corresponding log odds ratios are statistically significant and their attributable risks appear to be appreciable. During the model-building process, we discovered that penetrance for certain SNPs are strongly age-dependent, i.e., penetrance of a SNP could be appreciable in one age group, but is much less so in the other age group. In accordance to breast cancer biology and the age specific associations observed in the analyses, stratified analyses were performed for three age groups: 30-44, 45-54 and ≧55 years, likely representing pre-, peri- and post-menopausal age intervals.

### Example 2

### Results

Overall Associations with Breast Cancer Risk. Genotyping was performed for 117 common, functional polymorphisms in candidate genes likely to influence breast carcinogenesis. In the training set control population, all of the polymorphisms were tested for and met HW equilibrium expectations (data not shown). The results of an overall, age-independent logistic regression analyses of associations of these gene polymorphisms with breast cancer risk only identified a few polymorphisms with marginal associations with breast cancer risk (p<0.05).

Age-Stratified Associations with Breast Cancer Risk. The inventor's previous work and that of others had suggested the possibility of age-specific penetrance of some genetic polymorphisms. Because of the size of the present study, the inventors could productively stratify the analyses into three subgroups based on age at diagnosis for the cases and age of recruitment for the cancer-free controls. The three age groups used were 30-44 years, 45-54 years, and 55-69 years. These age-stratified analyses identified many main effects strongly associated with breast cancer risk in each of these age groups. For main effects the initial criteria for consideration as a term in the model was a p-value of ≦0.05. Subsequent age-stratified analyses also identified strong pairwise associations with risk that exhibited p-values of ≦0.001. These associations were evaluated for evidence of epistasis, i.e., gene-gene interactions with predictive capabilities greater than expected by examining them individually.

Age-Specific Models. Candidate terms originating from these analyses were evaluated by multivariate logistic regression to determine their weighting and develop the models integrating genetics and personal history. For the genetic terms the significant results derived from the stratified analyses supported the development of three age-specific sub-models that fit the data and predict risk far more accurately than any single model that could be derived from overall analyses. These sub-models encompassed the same three age categories used in the term identification process: 30-44; 45-55; 55-69 years of age. Each of these sub-models also comprised somewhat differing genetic effects along with different coefficients for the attribution of the Gail model to each of the age categories. The inventors chose to integrate the genetic terms with the Gail model over other risk models because it has been validated in both retrospective and prospective studies (Bondy et al., 1994) and was found to accurately access the breast cancer risk in populations of women who adhered to the ACS screening guidelines and received annual screening mammograms. These three sub-models were procedurally developed identically to the other models and used multivariate logistic regression analysis to fit the data. The complete listing of SNPs that were included in the models built is shown in Table 2. Overall, these three models include the analysis of 31 SNPs in 27 genes.

Table 3 summarizes the main effect and gene-gene interaction terms derived for the final models derived in each of the three age intervals. The 30-44 interval included 14 main effects and one gene pair, the 45-54 age interval included 10 main effects and no pairs while the 55-69 interval included 12 main effects and one pair. A total of seven of the SNPs (e.g., CYP1B2) are predictive terms in more than one age group and are aligned in the same row across Table 3. However, the contribution to risk prediction by a term that is informative in more than one age interval is not necessarily constant. This model contains several terms that exhibit age-specific penetrance with a reversal of risk, i.e., a given SNP genotype that predicts increased risk when a person is young leads to decreased risk at an older age. Only one marker (VDR-ApaI) is informative in all three age groups. For those genes in which multiple functional SNPs were considered, haplotype analyses were also performed to determine if the haplotypes would add additional predictive power to the model. In the genes under consideration, the models were not significantly improved by the inclusion of haploptypes in any of the age intervals. Finally, the tri-partite model includes pairwise gene interactions consisting of SNPs that are not included in the model as main effects. Consideration of these gene-gene (epistatic) interactions adds predictive power because they affect breast cancer risk in a manner not predictable by the main effects.

TABLE 1
ALL SNPs EXAMINED

| | | | | | SNP |
|---|---|---|---|---|---|
| SNP ID* | GENE SYMBOL | GENE NAME | CHROMOSOME | LOCATION | ALLELES |
| NA | ACCa (=ACACA) | acetyl-Coenzyme A carboxylase alpha | 17q21 | 5′UTR | T→C |
| | | | | 5′UTR-86 | |
| NA | ACCa (=ACACA) | acetyl-Coenzyme A carboxylase alpha | 17q21 | pIII | T→G |
| | | | | pIII-724 | |
| NA | ACCa (=ACACA) | acetyl-Coenzyme A carboxylase alpha | 17q21 | IVS8 | T→C |
| | | | | IVS8-16 | |
| NA | ACCa (=ACACA) | acetyl-Coenzyme A carboxylase alpha | 17q21 | IVS17 | T→C |
| | | | | IVS17 + 66 | |
| rs4646994 | ACE16 | Angiotensin I-Cconverting Enzyme | 17q23 | Alu, intron 16 | Ins/Del |
| rs1136410 | ADPRT | ADP-ribosyltransferase (NAD+; poly | 1q42 | Val762Ala | C→T |
| | | (ADP-ribose) polymerase) | | | |
| NA | BARD1 | BRCA1-Associated Ring Domain 1 | 2q34-q35 | Cys557Ser | G→C |
| rs1048108 | BARD1 (P24S) | BRCA1-Associated Ring Domain 1 | 2q34-q35 | Pro24Ser | C→T |
| rs2229571 | BARD1 (R378S) | BRCA1-Associated Ring Domain 1 | 2q34-q35 | Arg378Ser | G→C |
| NA | BRCA1 | Breast Cancer Protein Type 1 | 17q21 | 3875delGTCT | Wt/Mut |
| NA | BRCA1 | Breast Cancer Protein Type 1 | 17q21 | 4184delTCAA | Wt/Mut |
| rs799917 | BRCA1 | Breast Cancer Protein Type 1 | 17q21 | Pro830Leu | C→T |
| rs1799966 | BRCA1 | Breast Cancer Protein Type 1 | 17q21 | Ser1613Gly | A→G |
| rs206340 | BRCA2 | Breast Cancer Protein Type 2 | 13q12.3 | intron 24 | G→A |
| rs144848 | BRCA2 | Breast Cancer Protein Type 2 | 13q12.3 | Asn372His | C→A |
| rs 603965 | CCND1 | Cyclin D1 (PRAD1: parathyroid | 11q13 | Pro242Pro | G→A |
| | | adenomatosis 1) | | | |
| rs4680 | COMT | Catechol-O-methyltransferase | 22q11.2 | Val158Met | G→A |
| rs5275 | COX2 | Cyclooxygenase 2 | 1q25.2-25.3 | nt8473, 3′UTR | T→C |
| rs4646903 | CYP1A1 | Cytochrome P450 Family 1A, | 15q22-q24 | 3′UTR | T→C |
| | | polypeptide 1 | | | |
| rs1048943 | CYP1A1 | Cytochrome P450 Subfamily 1, | 15q22-24 | Ile462Val | A→G |
| | | polypeptide 1 | | | |
| rs10012 | CYP1B1 (R48G) | Cytochrome P450 SubFamily 1B | 2p22-p21 | Arg48Gly, exon 2 | C→G |
| rs1056836 | CYP1B1 (V432L) | Cytochrome P450, family 1, subfamily B, | 2p22-p21 | Val432Leu | C→G |
| | | polypeptide 1 | | | |
| rs1800440 | CYP1B1 (N453S) | cytochrome P450, family 1, subfamily B, | 2p22-p21 | Asn453Ser | A→G |
| | | polypeptide 1 | | | |
| rs1799998 | CYP11B2 | Cytochrome P450 Family XIB | 8q21 | promoter, nt-344 | C→T |
| | | polypeptide 2 | | | |
| rs743572 | CYP17 | Cytochrome P450, family 17, subfamily | 10q24.3 | 5′UTR | T→C |
| | | A, polypeptide 1 | | | |
| rs10046 | CYP19 (E10) | Cytochrome P450 Family 19 | 15q21.1 | 3′UTR, exon 10 | T→C |
| rs700519 | CYP19 (R264C) | Cytochrome P450 Family 19 | 15q21.1 | Arg 264Cys, Exon 8 | C→T |
| NA | CYP2D6 | Cytochrome P450, Subfamily IID, | 22q13.1 | Arg296Cys | C→T |
| | | polypeptide 6 | | | |
| rs16260 | ECAD | E-Cadherin | 16q22.1 | promoter, nt-160 | A→C |
| rs4444903 | EGF | Epidermal growth factor (beta- | 4q25 | 5′UTR, nt61 | G→A |
| | | urogastrone) | | | |
| rs1051740 | EPHX1 | Epoxide hydrolase (microsomal) | 1q42.1 | Tyr113His, exon 3 | T→C |
| rs2077647 | ERA | Estrogen Receptor α | 6q25.1 | codon 10 neutral | T→C |
| NA | ERCC1 | Excision repair cross-complementing | 19q13.2-q13.3 | 3′UTR (nt 8092) | C→A |
| | | rodent | | | |
| | | repair deficiency, complementation group 1 | | | |
| rs1052559 | ERCC2 | Excision repair cross-complementing | 19q13.3 | Lys751Gln | A→C |
| | (=XPD) | rodent repair deficiency, | | | |
| | | complementation group 2(xeroderma | | | |
| | | pigmentosum D) | | | |
| rs1800067 | ERCC4 (=XPF, | Excision repair cross-complementing | 16p13.3-p13.11 | Arg415Gln | G→A |
| | RAD1) | rodent | | | |
| | | repair deficiency, complementation group 4 | | | |
| rs1800682 | FAS (TNFRSF6) | Tumor Necrosis Receptor Superfamily | 10q24.1 | promoter, nt-670 | G→A |
| | | member 6 | | | |
| NA | FASL | FAS Ligand | 1q23 | 5′ promoter, nt-844 | T→C |
| NA | FGFR4 | Fibroblast Growth Factor 4 | 5q35.1-qter | Gly388Arg | G→A |
| rs681673 | GADD45 | Growth Arrest and DNA-Damage | 1p34-p12 | intron 3, nt 2441 | T→C |
| | | Inducible Gene 45 alpha | | | |
| NA | GSTM1 | Glutathione S-transferase (m family) | 1p13.3 | gene deletion (16 kb) | +/− |
| rs947894 | GSTP1 | Glutathione S-transferase pi | 11q13 | Ile105Val | G→A |
| rs1136201 | HER2 (=ERBB2) | v-erb-b2, erythroblastic leukemia viral | 17q21.1 | Ile655Val | A→G |
| OR | | oncongene | | | |
| rs1801200 | | | | | |
| rs1801201 | HER2 (=ERBB2) | v-erb-b2, erythroblastic leukemia viral | 17q21.1 | Ile654Val | A→G |
| | | oncongene | | | |
| rs1058808 | HER2 (=ERBB2) | v-erb-b2, erythroblastic leukemia viral | 17q21.1 | Ala1170Pro | G→C |
| | | oncongene | | | |
| rs1800562 | HLA-H (=HFE) | Hereditary Haemochromatosis Gene | 6p21.3 | Cys282Tyr | G→A |
| rs1799945 | HLA-H (=HFE) | Hereditary Haemochromatosis Gene | 6p21.3 | His63Asp | C→G |
| rs12628 | HRAS | Harvey rat sarcoma viral oncogene | 11p15.5 | nt81 codon 27, | T→C |
| | | homolog | | neutral | |
| rs5030382 | ICAM1 | Intercellular Adhesion Molecule 1 | 19p13.3-p13.2 | Lys469Glu | A→G |
| rs1056538 | ICAM5 | Intercellular Adhesion Molecule 5 | 19p13.2 | Val301Ile | G→A |
| NA | IGF2 | Insulin like Growth Factor 2 | 11p15.5 | nt 3580 | G→A |
| rs1800795 | IL6 | Interleukin 6 | 7p21 | promoter nt-174 | G→C |
| rs1800896 | IL-10 | Interleukin 10 | 1q31-q32 | Nt-1082, promoter | A→G |
| NA | INS | Insulin Receptor | 11p15.5 | nt1107 | C→T |
| rs5918 | ITGB3 | Integrin β3 | 17q21.32 | Leu33Pro | T→C |
| rs198977 | KLK2 | Kallikrein 2 | 19q13 | Arg226Trp | C→T |
| NA | KLK10 | Kallikrein 10 | 19q13.33 | Ala50Ser | G→T |
| rs1799986 | LRP1 | Low density lipoprotein receptor related | 12q13-1-q13.3 | Cys766Thr | C→T |
| | | protein 1 | | | |
| rs2279744 | MDM2 | Mouse double minute 2 homolog | 12q14-q15 | promoter, nt309 | T→G |
| rs12917 | MGMT | MethylGuanine - DNA | 10q26 | Leu84Phe | C→T |
| | | MethylTransferase | | | |
| rs2308321 | MGMT | MethylGuanine - DNA | 10q26 | Ile143Val | A→G |
| | | MethylTransferase | | | |
| rs1799977 | MLH1 | MutL homolog 1 | 3p21.3 | Ile219Val | A→G |
| rs1799750 | MMP1 | Matrix metalloproteinase 1 | 11q22.3 | −1607, promoter | G→GG |
| rs243865 | MMP2 | Matrix metalloproteinase 2 | 16q13-q21 | −1306, promoter | C→T |
| rs1799725 | MnSod | Manganese superoxide dismutase | 6q25.3 | Val16Ala | T→C |
| rs2333227 | MPO | Myeloperoxidase | 17q23.1 | promoter, nt-463 | G→A |
| rs3136229 | MSH6 | Mut S homolog 6 | 2p16 | nt-448, promoter-Sp1 | G→A |
| rs1801133 | MTHFR | 5,10-methylenetetrahydrofolate reductase | 1p36.3 | Ala222Val | C→T |
| | | (NADPH) | | | |
| rs4072037 | MUC1 | Mucin 1 | 1q21 | exon2, splicing | A→G |
| rs1041983 | NAT2 | N-acetylaminotransferase 2 | 8p22 | Tyr94Tyr (nt 282) | C→T |
| rs1801280 | NAT2 | N-acetylaminotransferase 2 | 8p22 | Ile114Th (nt341) | T→C |
| rs1805794 | NBS1 (=NIBRIN) | Nijmegen breakage syndrome 1 (nibrin), | 8q21-q24 | Glu185Gln | G→C |
| | | p95 protein of the MRE11/RAD50 | | | |
| | | complex | | | |
| rs2070744 | NOS | Nitric Oxide Synthase | 7q36 | promoter, nt-786 | T→C |
| rs1052133 | OGG1 | 8-@oxoguanine DNA glycosylase | 3p26.2 | Ser326Cys | C→G |
| N/A | PGR | Progesterone Receptor | 11q22-q23 | promoter, nt+331 | G→A |
| rs1042838 | PGR | Progesterone Receptor (PROGINS) | 11q22-q23 | Val660Leu | G→T |
| rs6917 | PHB | Prohibitin | 17q21 | 3'UTR | C→T |
| rs2233667 | PHB | Prohibitin | 17q21 | intron 5, nt 2582 | C→G |
| rs3856806 | PPARG | Peroxisome proliferator activated receptor γ | 3p25 | nt1431 | C→T |
| rs1801282 | PPARG | Peroxisome proliferator activated receptor γ | 3p25 | Pro12Ala | C→G |
| rs1801270 | p21 | Cyclin dependent kinase inhibitor 1A | 6p21.2 | Ser31Arg | C→A |
| rs2066827 | p27 | Cyclin dependent Kinase inhibitor 1B | 12p13 | Val109Gly | T→G |
| rs1042522 | P53 | Tumor protein p53 | 17p13.1 | Arg72Pro, exon 4 | G→C |
| rs1801173 | P73 | Tumor protein p73 | 1p36.3 | non-coding exon2, | C→T |
| rs13021 | PNN | Pinin | 14q21.1 | Ser671Gly | A→G |
| rs1726801 | POLD1 | DNA Polymerase delta 1 | 19q13.3 | Arg119His | G→A |
| rs1805329 | RAD23B | UV excision repair protein RAD23 | 9q31.2 | Ala249Val | C→T |
| | | homolog B (S. cerevisiae) | | | |
| rs28363284 | RAD51L3 | DNA repair protein RAD51 (S. cerevisiae)- | 17q11 | Glu233Gly | A→G |
| | (=RAD51D) | like 3 | | | |
| rs4796033 | RAD51L3 | DNA repair protein RAD51 (S. cerevisiae)- | 17q11 | Arg165Gln | G→A |
| | (=RAD51D) | like 3 | | | |
| rs3088074 | RAD54 (=ATRX, | Apha thalassemia/mental retardation | 1p32 | Gln929Glu | C→G |
| | RAD54L) | syndrome X-linked | | | |
| rs1799939 | RET | Rearranged during Transfection | 10q11.2 | Gly691Ser | G→A |
| | | protooncogene | | | |
| rs486907 | RNASEL (G/A) | Ribonuclesase L | 1q25 | Arg426Gln | G→A |
| NA | RNASEL (G/T) | Ribonuclease L | 1q25 | Asp541Gln | G→T |
| rs1799941 | SHBG | Sex Hormone Binding Protein | 17p13-p12 | 5′UTR | G→A |
| rs6259 | SHBG | Sex Hormone Binding Protein | 17p13-p12 | Asp356Asn | G→A |
| rs8191979 | SHC1 | SHC Transforming protein 1 | 1q21 | Met300Val | A→G |
| rs 4149396 | SULT1A1 | Sulfotransferase family, cytosolic, 1A, | 16p12.1-p11.2 | Arg213His | G→A |
| | | phenol-preferring, member 1 | | | |
| rs2273535 | STK15 | Serine Threonine protein kinase 15, | 20q | Phe31Ile | T→A |
| | | Aurora Kinase | | | |
| rs3817672 | TFR | Transferrin Receptor | 3q26.2-qter | Ser142Gly | A→G |
| rs1800469 | TGFβ1 | Transforming growth factor, beta 1 | 19q13.1 | promoter, (nt-509) | C→T |
| | | (Camurati-Engelmann disease) | | | |
| NA | TH | Tyrsine hydroxylase | 11p15.5 | nt-4217 | C→T |
| rs1041981 | TNFB | Tumor necrosis factor b | 6p21.3 | Thr26Asn | C→A |
| rs2073752 | TXNR | Thioredoxin Reductase 1 | 12q23-q24.1 | Ile340Thr | C→T |
| rs17868324 | UGT1A7 | UDP glycosyltransferase 1, family, | 2q37 | Arg131Lys | CG→AA |
| | | polypeptide A7 | | | |
| rs11692021 | UGT1A7 | UDP glycosyltransferase 1, family, | 2q37 | Trp208Arg | T→C |
| | | polypeptide A7 | | | |
| rs7975232 | VDR (ApaI) | Vitamin D (1,25-dihydroxyvitamin D3) | 12q12-q14 | ApaI | G→T |
| | | receptor | | | |
| rs1544410 | VDR-BsmI | Vitamin D (1,25-dihydroxyvitamin D3) | 12q12-q14 | intron 7 | G→A |
| | | receptor | | | |
| rs2228570 | VDR-Fok I | Vitamin D (1,25-dihydroxyvitamin D3) | 12q12-q14 | new ATG 5′end | C→T |
| | | receptor | | | |
| rs731236 | VDR-Taq I | Vitamin D (1,25-dihydroxyvitamin D3) | 12q12-q14 | 3′UTR | T→C |
| | | receptor | | | |
| rs3025039 | VEGF | Vascular endothelial growth factor | 6p12 | 3′UTR, nt936 | C→T |
| rs2228000 | XPC | Xeroderma Pigmentosum, | 3p25 | Ala499Val | C→T |
| | | Complementation group C | | | |
| rs2228001 | XPC | Xeroderma Pigmentosum, | 3p25 | Lys939Gln | A→C |
| | | Complementation group C | | | |
| rs17655 | XPG | Xeroderma Pigmentosum | 13q22 | Asp1104His | G→C |
| | | Complementation Group G | | | |
| rs1799782 | XRCC1 | X-ray repair complementing defective | 19q13.2 | Arg194Trp | C→T |
| | | repair in Chinese hamster cells 1 | | | |
| rs25487 | XRCC1 | X-ray repair complementing defective | 19q13.2 | Gln399Arg | A→G |
| | | repair in Chinese hamster cells 1 | | | |
| rs3218536 | XRCC2 | X-ray repair complementing defective | 7q36 | Arg188His | G→A |
| | | repair in Chinese hamster cells 2 | | | |
| rs861539 | XRCC3 | X-ray repair complementing defective | 14q32.3 | Thr241Met | C→T |
| | | repair in Chinese hamster cells 3 | | | |
| rs7830743 | XRCC7 (=PRKDC) | Protein kinase, DNA-activated, catalytic | 8q11 | Ile3433Thr | T→C |
| | | polypeptide | | | |

*rs reference numbers obtained from one of the following sites: www.ncbi.nlm.nih.gov/SNP/ or snp500cancer.nci.nih.gov

TABLE 2
RELEVANT SNPs and SNP Interactions

| Gene | Name | dbSNP ID | SNP | Function | Effect of SNP on Function | References(epi)* | References (function)** |
|---|---|---|---|---|---|---|---|
| ACCa (=ACACA) | Acetyl-coenzyme A | (5′UTR) | T→C | Rate limiting enzyme in the | Unknown | Sinilnikova et al. (2004) | Sinilnikova et al. (2004) |
| | carboxylase alpha | (IVS 17) | T→C | synthesis of long chain fatty acids. | | | |
| ADPRT | ADP-ribosyltransferase | rs1136410 | C→T | Chromatin associated enzyme | The Ala-allele has | Zhang et al. (2005) | Lockett et al. (2004) |
| | (NAD+; poly (ADP-ribose) | | | involved in base excision | significantly lower polyADP- | | |
| | polymerase) | | | repair that transfers ADP- | ribosylation activity. | | |
| | | | | ribose to nuclear proteins. | | | |
| CDKN1A (p21) | Cyclin Dependent Kinase | rs1801270 | C→A | Acts as the main executor of | Arg-allele is associated with | Lukas et al. (1997); | Shiohara et al. (1994) |
| | Inhibitor 1A | | | p53-induced growth arrest. | significantly decreased | Powell et al. (2002). | |
| | | | | | mRNA expression. | | |
| CDKN1B (p27) | Cyclin Dependent Kinase | rs2066827 | T→G | Inhibits the premature | Unknown, but hypothesized | Schondorf et al. (2004); | Cave et al. (1995); Li et al. |
| | Inhibitor 1B | | | activation of cyclin dependent | that this polymorphism may | Tigli et al (2005); Kibel | (2004); Schondorf et al. |
| | | | | kinases, specifically CyclinE- | affect protein degradation. | et al (2003). | (2004) |
| | | | | cdk2 complexes. | | | |
| CYP1A1 | Cytochrome P450 Family 1A, | rs4646903 | T→C | Oxidative metabolism of | Results in a highly inducible | Li et al. (2004); Hefler | Petersen et al. (1991); |
| | polypeptide 1 | | | principal estrogens: estradiol | and high activity enzyme. | et al. 2004. | Crofts et al. (1994) |
| | | | | and estrone through 2- and 4- | | | |
| | | | | hydroxylation | | | |
| CYP1B1 | Cytochrome P450 Family 1B, | rs10012 | C→G | Inactivation of estrogens via | Results in a high activity | Ahsan et al. (2004); | Bailey et al. (1998); Hanna |
| | polypeptide 1 | | | hydroxylation to catechol | enzyme. | Wen et al. (2005) | et al. (2000); Shimada et |
| | | | | estrogens. | | | al. (1999) |
| | | rs1800440 | A→G | | | | Stoilov et al. (1998) |
| CYP11B2 | Cytochrome P450 Family | rs1799998 | C→T | Renin-angiotensin system; | T-allele associated with | Listgarten et al. 2004. | Connell et al.(2004); |
| | XIB, polypeptide 2 | | | synthesis of aldosterone | increased aldosterone | | Barbato et al. (2004) |
| | | | | | secretion. | | |
| CYP 17 | Cytochrome P450, family 17, | rs743572 | T→C | Synthesis of sex steroids via | C-allele creates an additional | Spurdle et al., 2000; Ye | Feigelson et al., Haiman et |
| | subfamily A, polypeptide 1 | | | 17-alpha hydroxylation and | Sp-1 type promoter site | and Parry, 2002 | al., 1999 |
| | | | | 17,20-lyase activity. | leading to increased mRNA | | |
| | | | | | abundance | | |
| ERa | Estrogen Receptor alpha | rs2077647 | T→C | Nuclear hormone receptor | Unknown | Curran et al. (2001) | Iwase et al. (1996) |
| | | | | activated by estrogen leading | | | |
| | | | | to transcription of | | | |
| | | | | downstream genes. | | | |
| GADD45 | Growth Arrest and DNA | rs681673 | T→C | Induced in response to DNA | Unknown | Not available | Blaszyk et al. (1996) |
| | Damage-Inducible gene45 | | | damage, interacts with several | | | |
| | | | | cell cycle proteins and is a | | | |
| | | | | downstream target of p53. | | | |
| HLA-H (=HFE) | Hereditary | rs1799945 | C→G | Iron absorption and uptake | Asp variant results in | Abraham et al., 2005; | Feder et al. 1998 |
| | Haemochromatosis Gene | | | | increased cellular iron uptake. | Kallianpur et al. 2004. | |
| | | rs1800562 | G→A | | Tyr variant results in | | |
| | | | | | increased cellular iron uptake. | | |
| ICAM5 | Intercellular Adhesion | rs1056538 | G→A | Interacts with integrin and is | Unknown | Kammerer et al. (2004) | Kammerer et al. (2004) |
| | Molecule 5 | | | involved in cell adhesion and | | | |
| | | | | signaling. | | | |
| KLK2 | Kallikrein 2 | rs198977 | C→T | Serine protease that activates | Compared to the Arg-allele, | Chiang et al (2005); | Herrala et al.(1997) |
| | | | | other kallikreins, growth | the Trp-allele had no | Nam et al. (2003). | |
| | | | | factor binding proteins, | detectable protease activity. | | |
| | | | | peptide hormones and | | | |
| | | | | components of basement | | | |
| | | | | membrane. | | | |
| KLK10 | Kallikrein 10 | (Ala50Ser) | G→T | Unknown, but expressed pre- | Unknown | Bharaj et al. (2005) | Bharaj et al. (2005) |
| | | | | dominantly in the skin and | | | |
| | | | | breast. Responsive to | | | |
| | | | | estrogen but its expression is | | | |
| | | | | down regulated in breast | | | |
| | | | | cancer. | | | |
| MMP2 | Matrix Metalloproteinase 2 | rs243865 | C→T | Zinc dependent proteolytic | Polymorphism leads to a | Grieu et al. (2004); | Price et al. (2001) |
| | | | | enzyme that degrades | disruption of a Sp1 binding | Zhou et al. (2004); | |
| | | | | extracellular matrix | site leading to decreased | | |
| | | | | components leading to tumor | promoter activity. | | |
| | | | | invasion. | | | |
| MnSod | Manganese superoxide | rs1799725 | T→C | Intra-mitochondrial, | Polymorphism occurs in the | Ambrosone et al.(2005); | Rosenblum et al. (1996) |
| | dismutase | | | manganese-dependent, free | signal peptide, may affect | Mitrunen et al.(2001); | |
| | | | | radical scavenging enzyme | protein transport. Effect on | Ambrosone et al.(1999) | |
| | | | | that metabolizes ROS to | function not completely | | |
| | | | | hydogen peroxide. | elucidated. | | |
| MPO | Myeloperoxidase | rs2333227 | G→A | Lysosomal heme protein | Polymorphism leads to a | Ambrosone et al. | Reynolds et al. (2000) |
| | | | | located in PMNs. Involved in | disruption of a Sp1 binding | (2005); Ahn et al. | |
| | | | | destruction of | site leading to decreased | (2004) | |
| | | | | microorganisms by | promoter activity. A-allele | | |
| | | | | generation of ROS from | associated with lower | | |
| | | | | hydrogen peroxide. Also | carcinogen-DNA adduct | | |
| | | | | activates carcinogens by | levels. | | |
| | | | | similar mechanism. | | | |
| MSH6 | mut S homolog 6 | rs3136229 | G→A | Belongs to the DNA | The A-allele results in loss of | Not available | Gazzoli et al.(2003) |
| | | | | mismatch repair (MMR) | Sp-1 transcription factor | | |
| | | | | system. Forms heterodimers | binding and a 50% reduction | | |
| | | | | with MSH2 to recognize | in promoter acitivity | | |
| | | | | mispaired bases in DNA. | | | |
| P53 | Tumor Protein 53 | rs1042522 | G→C | Multifunctional transcription | Pro-allele induced apoptosis | Noma et al. (2004); | Matlashewski et al. (1987); |
| | | | | factor that acts as a master | at a much slower rate and did | Kalemi et al. (2005); | Marin et al. (2000); |
| | | | | regulator of cell cycle | not suppress transformation | Tommiska et al. (2005) | Thomas et al (1999). |
| | | | | progression, DNA damage | as efficiently as the Arg- | | |
| | | | | and apoptosis | allele. | | |
| PGR | Progesterone Receptor | rs1042838 | G→T | Steroid receptor that mediates | Unknown | Pooley et al.(2006); | Not available |
| | | | | the effects of progesterone | | Spurdle et al (2002) | |
| | | | | hormone. | | | |
| RAD51L3 | DNA repair protein | rs4796033 | G→A | DNA repair of double strand | Unknown | Rodriguez-Lopez et al. | Rodriguez-Lopez et al. |
| | RAD51L3 (aka RAD51D) | | | breaks by homologous | | (2004) | (2004) |
| | | | | recombination. Interacts with | | | |
| | | | | BRCA1 and BRCA2. | | | |
| STK15 | Serine Threonine Protein | rs2273535 | T→A | Involved in the induction of | Alters kinase function, Ile- | Cox et al. (2006); Egan | Ewart-Toland et al.(2003) |
| | Kinase 15 | | | centrosome duplication and | allele preferentially amplified | et al. (2004); Sun et al. | |
| | | | | chromosome segregation | and associated with | (2004) | |
| | | | | during mitosis. | aneuploidy in human tumors. | | |
| TFR | Transferrin Receptor | rs3817672 | A→G | Glycoprotein responsible for | Unknown | Beckman et al. 1999, | Evans and Kemp (1997) |
| | | | | iron transport in blood and | | 2000 | |
| | | | | facilitates iron uptake by the | | | |
| | | | | cell. | | | |
| UGT1A7 | UDP glycosyltransferase 1, | rs17868324 | CG→AA | Detoxification (by | Linked with the Trp 208 Arg | Araki et al. (2005); vander | Zheng et al. (2001); |
| | family, polypeptide A7 | | | glucuronidation) of lipophilic | polymorphism. The 131 Arg- | Logt et al. (2004); | Strassburg et al. (2002). |
| | | | | xenobiotics, hormones and | 208Trp allele exhibits the | Vogel et al. (2002). | |
| | | | | drugs. | highest enzyme activity and | | |
| | | | | | 131Lys-208Arg shows the | | |
| | | | | | lowest enzyme activity. | | |
| VDR | Vitamin D (1,25- | Rs7975232 | G→T | Nuclear hormone receptor | Unknown, no change in | Silanpaa et al.(2004); | Faraco et al(1989) |
| | dihydroxyvitamin D3) | (Apal) | | that regulates bone | mRNA or protein levels. | Curran et al. (1999) | |
| | receptor | rs2228570 | C→T | metabolism, immune | C-allele results in protein that | Curran et al.(1999); Guy | Gross et al(1996) |
| | | (FokI) | | response, cell proliferation | differs in length by 3 amino | et al.(2003); Ingles et | |
| | | | | and differentiation, | acids | al.(1997) | |
| XPG | Xeroderma Pigmentosum, | rs17655 | G→C | Magnesium dependent, DNA | The His/His variant has lower | Vodicka et al. (2004); | Nousipikel and Clarkson |
| | Group G correcting protein | | | endonuclease involved in | repair capacity compared with | Kumar et al. (2003); Cui | (1994) |
| | | | | nucleotide excision repair | the Asp-allele. | et al. (2005) | |
| | | | | following DNA damage. | | | |
| XRCC1 | X-ray Repair, | rs25487 | A→G | Repairs DNA single-strand | Polymorphism lies in the | Shen et al. (2005); | Shen et al. (1998); Shu et |
| | Complementing defective in | | | breaks by the base excsion | PARP binding site. Carriers | Sigurdson et al. (2004); | al. (2003). |
| | Chinese hamster, 1 | | | repair pathway and promotes | of the A-allele exhibit | Shu et al. (2003); | |
| | | | | gneetic stability, | increased levels of genotoxic | Figueiredo et al. (2004). | |
| | | | | | damage. | | |

31 SNPs in 27 Genes
*References for epidemiological studies

TABLE 3

| 30-44 | 45-54 | 55-69 | |
|---|---|---|---|
| Gail Relative Risk | Gail Relative Risk | Gail Relative Risk | Total SNP List |
| | | ACCa_5UTR_C/C↓; C/T↓ | ACCa_5UTR_SNP119 |
| ACCa_IVS17_C/C↓; C/T [symbol] | ACCa_IVS17_C/C↓; C/T↓ | | ACCa_IVS17_SNP122 |
| | ADPRT_V762A_C/C↓; C/T↑ | | ADPRT_V762A_SNP80 |
| | CYP1A1_m2/m2↓; m1/m2↓ | | CYP11B2_R SNP33 |
| | | CYP1B1_R48G_G/G↑: C/G↑ | CYP1A1_SNP60 |
| CYP1B1_N453S_G/G↑_G/A↓ | CYP1B1_N453S_G/G [symbol] ; G/A↓ | | CYP1B1_R48G_SNP40 |
| CYP11B2_C/C↓; C/T↓ | | | CYP1B1_N453S_SNP112 |
| ERA_10_C/C↓; C/T↑ | | | CYP17 SNP12 |
| GADD45_C/C↑; C/T↓ | | | ERA_10_SNP53 |
| | | HLAh_C282Y_A/A↑; G/A↓ | GADD45_SNP132 |
| | HLAh_H63D_G/G↑; C/G↑ | | HLAh_C282Y_SNP89 |
| ICAM5_A/A↓; G/A↓ | | ICAM5_A/A↓; G/A↑ | HLAh_H63D_SNP90 |
| | | KLK2_792_T/T↑; C/T↑ | ICAM5_SNP134 |
| KLK10_150_T/T↑; T/G↑ | KLK10_150_T/T↑; T/G↑ | | KLK10_150_SNP59 |
| | | MMP2_T/T↑; C/T [symbol] | KLK2_792_SNP58 |
| | MnSOD_C/C↑; C/T↓ | | MMP2_SNP42 |
| | | | MnSOD_SNP63 |
| | MPO463_A/A↑; G/A↑ | MPO463_A/A↑; G/A↓ | MPO463_SNP35 |
| MSH6_A/A↓; G/A↓ | | | MSH6_SNP_106 |
| p21_A/A↓; A/C↓ | | | p21_SNP64 |
| P53_L2_C/C↑; C/G [symbol] | | | p27_SNP32 |
| | PGR_V660L_T/T↑; T/G↑ | | P53_L2_SNP37 |
| | | RAD51L3_R165Q_A/A↑; G/A↓ | PGR_V660L_SNP49 |
| | | STK15_A/A↑; A/T↑ | RAD51L3_R165Q_SNP111 |
| TFR_S142G_G/G↓; G/A↓ | | | STK15_SNP25 |
| UGT1A7131_CG/CG↑; AA/CG↑ | | UGT1A7131_CG/CG↓; AA/CG↓ | TFR_S142G_SNP91 |
| VDR_ApaI_a1/a1↓; A2/a1↓ | VDR_ApaI_a1/a1↓; A2/a1↓ | VDR_ApaI_a1/a1↓; A2/a1↓ | UGT1A7-131_SNP41a |
| | | VDR_FokI_f1/f1↓; F2/f1↓ | VDR_ApaI_SNP5 |
| XPG_C/C↓; C/G↑ | | | VDR_FokI_SNP62 |
| | | | XPG_SNP66 |
| | | | XRCC1_Q399R SNP75 |
| Total = 14 + 2 = 16 | Total = 10 | Total = 12 | Total SNPs = 31 |
| | | | Total Genes = 27 |
| Interactions | | | |
| p27_SNP32 + XRCC1_Q399R | | CYP11B2_R_SNP33 + CYP17 | |
| SNP75 Epistatic G/*-A/*↑ | | SNP12 Epistatic T/T-T/*↓ | |

Green shading refers to SNP appearing in more than one age group

### Example 3

### Conclusion

In summary, the inventors have examined genetic polymorphisms in a number of genes and have determined their association, alone and in combination, with breast cancer risk. The unexpected results of these experiments were that, considered individually, the examined genes and their polymorphisms were only modestly associated with breast cancer risk. However, when examined in combination of two, three or more, complex genotypes with wide variation in breast cancer risk were identified. This information has great utility in facilitating the most effective and most appropriate application of cancer screening and chemoprevention protocols, with resulting improvements in patient outcomes.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### IX. REFERENCES

The following references, to the extent that they provide exemplary procedural or other details supplementary to those set forth herein, are specifically incorporated herein by reference.
U.S. Pat. No. 4,683,195
U.S. Pat. No. 4,683,202
U.S. Pat. No. 4,800,159
U.S. Pat. No. 4,883,750
U.S. Pat. No. 5,578,832
U.S. Pat. No. 5,837,832
U.S. Pat. No. 5,837,860
U.S. Pat. No. 5,861,242
U.S. Pat. No. 6,159,693
Abraham et al., Cancer Epidemoil. Biomarkers Prev, 14(5): 1102-1107, 2005.
Ahn et al., Cancer Res., 64(20):7634-7639, 2004.
Ahsan et al., Breast Cancer Res. Treat., 85(2):121-131, 2004.
Ambrosone et al. Cancer Res., 65(3):1105-1111, 2005.
Ambrosone et al., Cancer Res., 59(3):602-606, 1999.
Araki et al., Eur. J. Cancer, 41(15)2360-2365, 2005.
Aston et al., Hum Genet. 116(3):208-21, 2005 (Epub 2004 December 21).
Bailey et al., Cancer Res., 58(22):5038-5041, 1998.
Barbato et al., J. Hypertens., 22(10):1895-1901, 2004.
Beckman et al., Carcinogenesis, 20(7):1231-1233, 1999.
Beckman et al., Oncology, 59(4):317-322, 2000.
Bharaj et al., Prostate, 51(1):35-41, 2002.
Blaszyk et al., Hum. Genet., 97(4):543-547, 1996.
Bondy et al., J. Natl. Cancer Inst. 86(8):620-5, 1994. British Appl. GB 2,202,328
Cave et al., Ann. Genet., 39(2):108, 1995.
Chiang et al., J. Urol., 173(2):429-432, 2005.
Connell et al., Mol. Cell. Endocrinol., 217(1-2):243-247, 2004.
Costantino et al., J. Natl. Cancer Inst., 91:1541-1548, 1999.
Cox et al., Cancer Causes Control, 17(1):81-93, 2006.
Crofts et al. Carcinogenesis, 15(12):2961-2963, 1994.
Cui et al., Int. J. Cancer, 118(3):714-720, 2006.
Curran et al., Int. J. Cancer, 93(6):723-726, 1999.
Curran et al., Int. J. Cancer, 95(4):271-275, 2001.
Egan et al., Carcinogenesis, 25(11):2149-2153, 2004.
European Patent Appln. 320,308
European Patent Appln. 329,822
Evans and Kemp, Gene, 199(1-2):123-131, 1997.
Ewart-Toland et al., Carcinogenesis, 26(8):1368-1373, 2005.
Faraco et al., Nucleic Acids Res., 17:2150, 1989.
Feder et al., Proc. Natl. Acad. Sci. USA, 95(4):1472-1477, 1998.
Feigelson et al., Cancer Res., 59(16):3908-3910, 1999.
Figueiredo et al., Cancer Epidemiol. Biomarkers Prev., 13(4):583-591, 2004.
Fodor et al., Biochemistry, 30(33):8102-8108, 1991.
Frohman, In: PCR Protocols. A Guide To Methods And Applications, Academic Press, N.Y., 1990.
Gail et al. J. Natl. Cancer Inst., 81:1879-1886, 1989
Gazzoli et al., Mol. Cell. Biol., 23(22):7992-8007, 2003.
Grieu et al., Breast Cancer Res. Treat., 88(3):197-204, 2004.
Gross et al., J. Bone Miner Res., 11(12):1850-1855, 1996.
Guy et al., Recent Results Cancer Res., 164:43-54, 2003.
Hacia et al., Nature Genet., 14:441-449, 1996.
Haiman et al., Cancer Res., 59(5):1015-1020, 1999.
Hanna et al., Cancer Res., 60(13):3440-3444, 2000.
Hefler et al., Cancer, 101(2):264-249, 2004.
Herrala et al., Clin. Chem., 43(2):279-284, 1997.
Holmstrom et al., Anal. Biochem. 209:278-283, 1993.
Ingles et al., Cancer Epidemiol. Biomarkers Prev., 6(2):93-98, 1997.
Iwase et al., Cancer Lett., 108(2):179-184, 1996.
Kalemi et al., Cancer Lett., 222(1):57-65, 2005.
Kallianpur et al., Cancer Epidemiol. Biomarkers Prev., 13(2):205-212, 2004.
Kammerer et al., Cancer Res., Cancer Res., 64(24):8906-8910, 2004.
Kibel et al., Cancer Res., 63(9):2033-2036, 2003.
Kumar et al., Int. J. Cancer, 103(5):671-675, 2003.
Kwoh et al., Proc. Natl. Acad. Sci. USA, 86:1173, 1989.
Lander and Schork, Science, 30:265:2037-2048, 1994.
Li et al., Breast Cancer Res., 6(4):R460-473, 2004.
Li et al., Clin. Cancer Res., 10(12 Pt 1):3996-4002, 2004.
Listgarten et al., Clin. Cancer Res., 10(8):2725-2737, 2004.
Lockett et al., Cancer Res., 64(17):6344-6348, 2004.
Lukas et al., Am. J. Pathol., 150(1):167-175, 1997.
Marin et al., Nat. Genet., 25(1):47-54, 2000.
Matlashewski et al., Mol. Cell Biol., 7(2):961-963, 1987.
McTiernan et al., Cancer Epidemiol Biomarkers Prev., 10:333-338, 2001.
Mitrunen et al., Carcinogenesis, 22(5):827-829, 2001.
Nam et al., J. Clin. Oncol., 21(12):2312-2319,2003.
Newton et al., Nucl. Acids Res., 21:1155-1162, 1993.
Noma et al., Cancer Lett., 210(2):197-203, 2004.
Nouspikel and Clarkson, Hum. Mol. Genet., 3(6):963-967, 1994.
Ohara et al., Proc. Natl. Acad. Sci. USA, 86:5673-5677, 1989.
PCT Appln. PCT/US87/00880
PCT Appln. PCT/US89/01025
PCT Appln. WO 2003/025141
PCT Appln. WO 2005/024067
PCT Appln. WO 88/10315
PCT Appln. WO 89/06700
PCT Appln. WO 90/07641
Pease et al., Proc. Natl. Acad. Sci. USA, 91:5022-5026, 1994.
Petersen et al., Am. J. Hum. Genet., 49(4):720-725, 1991.
Pooley et al., Cancer Epidemiol. Biomarkers Prev., 15(4):675-682, 2006.
Powell et al., Carcinogenesis, 23(2):311-315, 2002.
Price et al., J. Biol. Chem., 276(10):7549-7558, 2001.
Rasmussen et al., Anal. Biochem., 198:138-142, 1991.
Reddy and Chow, Am. J. Health Syst. Pharm., 57:1315-2132, 2000.
Reynolds et al., Neurology, 55(9):1284-1290, 2000.
Rodriguez-Lopez et al., Int. J. Cancer, 110(6):845-849, 2004.
Rosenblum et al., Proc. Nat. Acad. Sci. USA, 93:4471-4473, 1996.
Running et al., BioTechniques 8:276-277, 1990.
Sambrook et al., In: Molecular Cloning: A Laboratory Manual, 2d Ed., Cold Spring Harbor Laboratory Press, Cold Spring Harbor, N.Y., 2001.
Schondorf et al., Tumour Biol., 25(5-6):306-312, 2004.
Shen et al., Cancer Epidemiol. Biomarkers Prev., 14(2):336-342, 2005.
Shen et al., Cancer Res., 58(4):604-608, 1998.
Shimada et al., Carcinogenesis, 20(8):1607-1613, 1999.
Shiohara et al., Blood, 94(11):3781-3784, 1994.
Shoemaker et al., Nature Genetics, 14:450-456, 1996.
Shu et al., Cancer Epidemiol. Biomarkers Prev., 12(12):1462-1467, 2003.
Sigurdson et al., BMC Cancer, 4:9-20, 2004.
Sillanpaa et al., Pharmacogenetics, 14(4):239-245, 2004.
Sinilnikova et al., Carcinogenesis, 25:2417-2424, 2004.
Spurdle et al., Cancer Epidemiol. Biomarkers Prev., 11(5):439-443, 2002.
Spurdle et al., J. Natl. Cancer Inst., 92(20):1674-1681, 2000.
Stoilov et al., Am. J. Hum. Genet., 62(3):573-584, 1998.
Strassburg et al., Gut., 50(6):851-856, 2002.
Sun et al., Carcinogenesis, 25(11):2225-2230, 2004.
Thomas et al., Mol. Cell Biol., 19(2):1092-1100, 1999.
Tigli et al., Mol. Diagn., 9(1):17-21, 2005.
Tommiska et al., Clin. Cancer Res., 11(14):5098-5103, 2005.
van der Logt et al., Carcinogenesis, 25(12):2407-2415, 2004.
Vodicka et al., Carcinogenesis, 25(5):757-763, 2004.
Vogel et al., Z. Gastroenterol., 40(7):497-502, 2002.
Walker et al., Nucleic Acids Res., 20(7): 1691-1696, 1992.
Wen et al., Cancer Epidemiol. Biomarkers Prev., 14(2):329-335, 2005.
Wu and Wallace, Genomics, 4:560-569, 1989.
Ye and Parry, Mutagenesis, 17(2):119-126, 2002.
Ye et al., Hum. Mutat., 17(4):305-16, 2001.
Zhang et al., Cancer Res., 65(3):722-726, 2005.
Zheng et al., J. Natl. Cancer Inst., 93(18):1411-1418, 2001.
Zhou et al., Carcinogenesis, 25(3):399-404, 2004.

What is claimed is:

1. A method for assessing a female subject's risk for developing breast cancer comprising determining, in a sample from said subject, the allelic profile of more than one SNP selected from the group consisting of ACCa (IVS17) T→C, ACCa (5′UTR) T→C, ADPRT (rs1136410) C→T, CYP1A1 (rs4646903) T→C, CYP1B1 (rs1800440) A→G, GADD45 (rs681673) T→C, HLAh (rs1799945) C→G, HLAh (rs1800562) G→A, ICAM5 (rs1056538) G→A, KLK10 (Ala50Ser) G→T, KLK2 (rs198977) C→T, MPO463 (rs2333227) G→A, MSH6 (rs3136229) G→A, PGR (rs1042838) G→T, RAD51L3 (rs4796033) G→A, STK15 (rs2273535) T→A and TFR (rs3817672) A→G.

2. The method of claim 1, further comprising determining the allelic profile of (a) p27 (rs2066827) T→G and XRCC1 (rs25487) A→G; and/or (b) CYP11B2 (rs1799998) C→T and CYP17 (rs743572) T→C.

3. The method of claim 1, further comprising determining the allelic profile of at least one additional SNP selected from the group consisting of CYP11B2 (rs1799998) C→T, CYP1B1 (rs10012) C→G, CYP17 5′UTR (rs743572) T→C, ERα (rs2077647) T→C, MMP2 (rs243865) C→T, MnSOD (rs1799725) T→C, p21 (rs1801270) C→A, p27 (rs2066827) T→G, p53 (rs1042522) G→C, UGT1A7 (rs17868324) CG→AA, VDR ApaI (rs7975232) G→T, VDR FokI (rs2228570) C→T, XPG (rs17655) G→C, and XRCC 1 (rs25487) A→G.

4. The method of claim 3, further comprising determining the allelic profile of (a) p27 (rs2066827) T→G and XRCC1 (rs25487) A→G; and/or (b) CYP11B2 (rs1799998) C→T and CYP17 (rs743572) T→C.

5. The method of claim 1, further comprising assessing one or more aspects of the subject's personal history.

6. The method of claim 1, wherein said one or more aspects are selected from the group consisting of age, ethnicity, reproductive history, menstruation history, use of oral contraceptives, body mass index, alcohol consumption history, smoking history, exercise history, diet, family history of breast cancer or other cancer including the age of the relative at the time of their cancer diagnosis, and a personal history of breast cancer, breast biopsy or DCIS, LCIS, or atypical hyperplasia.

7. The method of claim 6, wherein one or more aspects comprises age.

8. The method of claim 7, wherein age comprises stratification into a young age group of age 30-44 years, middle age group of age 45-54 years, and an old age group of 55 years and older.

9. The method of claim 1, wherein determining said allelic profile is achieved by amplification of nucleic acid from said sample.

10. The method of claim 9, wherein amplification comprises PCR.

11. The method of claim 9, wherein primers for amplification are located on a chip.

12. The method of claim 9, wherein primers for amplification are specific for alleles of said genes.

13. The method of claim 9, further comprising cleaving amplified nucleic acid.

14. The method of claim 9, wherein said sample is derived from oral tissue or blood.

15. The method of claim 1, further comprising making a decision on the timing and/or frequency of cancer diagnostic testing for said subject.

16. The method of claim 1, further comprising making a decision on the timing and/or frequency of prophylactic cancer treatment for said subject.

17. A nucleic acid microarray comprising nucleic acid sequences corresponding to genes at least one of the alleles for each of ACCa (IVS17) T→C, ACCa (5′UTR) T→C, ADPRT (rs1136410) C→T, CYP1A1 (rs4646903) T→C, CYP1B1 (rs1800440) A→G, GADD45 (rs681673) T→C, HLAh (rs1799945) C→G, HLAh (rs1800562) G→A, ICAM5 (rs1056538) G→A, KLK10 (Ala50Ser) G→T, KLK2 (rs198977) C→T, MPO463 (rs2333227) G→A, MSH6 (rs3136229) G→A, PGR (rs1042838) G→T, RAD51L3 (rs4796033) G→A, STK15 (rs2273535) T→A and TFR (rs3817672) A→G.

18. The nucleic acid microarray of claim 17, wherein said nucleic acid sequences comprise sequences for both alleles for each of said genes.

19. A method for determining the need for routine diagnostic testing of a female subject for breast cancer comprising determining, in a sample from said subject, the allelic profile of more than one SNP selected from the group consisting of ACCa (IVS17) T→C, ACCa (5′UTR) T→C, ADPRT (rs1136410) C→T, CYP1A1 (rs4646903) T→C, CYP1B1 (rs1800440) A→G, GADD45 (rs681673) T→C, HLAh (rs1799945) C→G, HLAh (rs1800562) G→A, ICAM5 (rs1056538) G→A, KLK10 (Ala50Ser) G→T, KLK2 (rs198977) C→T, MPO463 (rs2333227) G→A, MSH6 (rs3136229) G→A, PGR (rs1042838) G→T, RAD51L3 (rs4796033) G→A, STK15 (rs2273535) T→A and TFR (rs3817672) A→G.

20. A method for determining the need of a female subject for prophylactic anti-breast cancer therapy comprising determining, in a sample from said subject, the allelic profile of more than one SNP selected from the group consisting of ACCa (IVS17) T→C, ACCa (5′UTR) T→C, ADPRT (rs1136410) C→T, CYP1A1 (rs4646903) T→C, CYP1B1 (rs1800440) A→G, GADD45 (rs681673) T→C, HLAh (rs1799945) C→G, HLAh (rs1800562) G→A, ICAM5 (rs1056538) G→A, KLK10 (Ala50Ser) G→T, KLK2 (rs198977) C→T, MPO463 (rs2333227) G→A, MSH6 (rs3136229) G→A, PGR (rs1042838) G→T, RAD51L3 (rs4796033) G→A, STK15 (rs2273535) T→A and TFR (rs3817672) A→G.
